(19) United States
(12) Patent Application Publication
(10) Pub. No.: US 2025/0062330 A1
(43) Pub. Date: Feb. 20, 2025

(54) TRANSITION-METAL-OXIDE-BASED ELECTRODES FOR AQUEOUS ELECTROCHEMICAL CELLS

(71) Applicant: Alsym Energy, Inc., Woburn, MA (US)

(72) Inventors: Daniel Anthony Evans, Melrose, MA (US); Jae Hyo-Han, Cambridge, MA (US); Kirk Hutchinson, Sudbury, MA (US); Robert William Atkinson, III, Winchester, MA (US); Mohammad Alaghemandi, Watertown, MA (US); Rahul Mukherjee, Winchester, MA (US); Blayne Phillips, Wilmington, MA (US); Nicholas Ryan Kamm, Melrose, MA (US); Christopher Ryan Marsh, Waltham, MA (US); Alolika Mukhopadhyay, Wilmington, MA (US); Brian Crowley, Brookline, MA (US); David Wheeler, Allston, MA (US)

(21) Appl. No.: 18/670,703

(22) Filed: May 21, 2024

Related U.S. Application Data
(60) Provisional application No. 63/468,223, filed on May 22, 2023.

(51) Int. Cl. H01M 4/485; H01M 4/02; H01M 4/131; H01M 4/62; H01M 4/66; H01M 10/36

(52) U.S. Cl. CPC H01M 4/485; H01M 4/131; H01M 4/621; H01M 4/625; H01M 4/661; H01M 10/36; H01M 2004/021; H01M 2004/027

(57) ABSTRACT

Transition metal oxide-based electrodes for electrochemical cells and electrochemical cells (e.g., aqueous electrochemical cells) comprising them are presented herein. Additionally, methods of preparation of the same are presented. In some embodiments, a transition metal oxide of a redox active material includes a tungsten oxide.

### CROSS-REFERENCE TO RELATED APPLICATION

This application claims priority to U.S. Provisional Application No. 63/468,223, filed May 22, 2023, the disclosure of which is incorporated by reference herein in its entirety.

### TECHNICAL FIELD

This disclosure relates generally to aqueous electrochemical cells comprising transition metal oxides (TMOs).

### BACKGROUND

Energy storage devices, such as electrochemical cells, generally include two electrodes (an anode and a cathode), a separator, and an electrolyte. These few components nonetheless present a complex electrochemical environment. The complex electrochemical environment can mar the performance of the electrochemical cell, for example through the occurrence of undesirable side reactions and/or electrochemical passivation, either at one or more of the electrodes, in the electrolyte, or between one or more of the electrodes and the electrolyte. There is a need, therefore, for electrode compositions that mitigate such undesirable side reactions and/or electrochemical passivation and/or promote electrochemical stability and/or kinetics in an energy storage device, such as an aqueous secondary battery.

### SUMMARY

Presented herein are, inter alia, transition metal oxide-based electrodes for use in aqueous electrochemical cells which are intended to provide for improved electrochemical cells which comprise various embodiments disclosed herein relative to conventional aqueous electrochemical cells. For example, disclosed embodiments may provide for, inter alia, improved electrochemical performance parameters including, but not limited to, charge storage capacity, cycling stability, and voltage stability window (e.g., between −1V vs. Ag/AgCl and +1V vs. Ag/AgCl; between −1.3V vs. Ag/AgCl and +1.3V vs. Ag/AgCl; between −1.6V vs. Ag/AgCl and +1.6V vs. Ag/AgCl; between 10° C. and 35° C.; between 0° C. and 40° C.; between −15° C. and +50° C.).

In some aspects, the present disclosure is directed to an electrode composition for an electrochemical cell. The electrode composition may include a redox active material. The redox active material may include a tungsten oxide.

In some embodiments, the tungsten oxide has a layered structure. In some embodiments, the redox active material has a layered structure. In some embodiments, the tungsten oxide has a formula of X₂W₂O₇ where X is a group I element (e.g., an alkali metal or hydrogen) (e.g., Li₂W₂O₇, Na₂W₂O₇, K₂W₂O₇, or H₂W₂O₇). In some embodiments, the tungsten oxide has a cubic or hexagonal crystal structure. In some embodiments, the redox active material has a cubic or hexagonal crystal structure. In some embodiments, the tungsten oxide comprises WO₃. In some embodiments, the redox active material comprises WO₃. In some embodiments, the tungsten oxide has a formula of zH₂O*WO₃, preferably where 0<z≤1. In some embodiments, the redox active material comprises zH₂O*WO₃, preferably where 0<z≤1. In some embodiments, the tungsten oxide comprises hydrogen. In some embodiments, the tungsten oxide is hydrated. In some embodiments, the redox active material is hydrated. In some embodiments, the tungsten oxide is a reduced tungsten oxide. In some embodiments, the redox active material comprises a reduced tungsten oxide.

In some embodiments, the redox active material has a structure that generates an x-ray diffraction pattern (e.g., x-ray powder diffraction pattern) using a Cu source that has a major peak measured at 2θ in (i) a range of 6° to 12°, (ii) a range of 16° to 22°, (iii) a range of 22° to 28°, (iv) a range of 25° to 31°, (v) a range of 26° to 32°, (vi) a range of 31° to 37°, or (vii) a combination thereof (e.g., has at least two major peaks each in one of at least two of (i)-(vi), has at least three major peaks each in one of at least three of (i)-(vi), has at least four major peaks each in one of at least four of (i)-(vi), or has at least five major peaks each in one of at least five of (i)-(vi)). In some embodiments, the tungsten oxide has a structure that generates an x-ray diffraction pattern (e.g., x-ray powder diffraction pattern) using a Cu source that has a major peak measured at 2θ in (i) a range of 6° to 12°, (ii) a range of 16° to 22°, (iii) a range of 22° to 28°, (iv) a range of 25° to 31°, (v) a range of 26° to 32°, (vi) a range of 31° to 37°, or (vii) a combination thereof (e.g., has at least two major peaks each in one of at least two of (i)-(vi), has at least three major peaks each in one of at least three of (i)-(vi), has at least four major peaks each in one of at least four of (i)-(vi), or has at least five major peaks each in one of at least five of (i)-(vi)).

In some embodiments, the tungsten oxide is doped. In some embodiments, the tungsten oxide is doped with tin. In some embodiments, the tungsten oxide is doped at a concentration in a range from 5% to 15% (e.g., from 6% to 12% or from 7% to 11%). In some embodiments, the tungsten oxide is doped at a concentration in a range from 1% to 15% (e.g., from 1% to 10%, from 2% to 14%, from 3% to 13%).

In some embodiments, the electrode composition includes particles that include the redox active material. In some embodiments, the electrode composition includes secondary particles including the particles. In some embodiments, a d50 particle size of the particles is in a range of from 0.01 μm to 2 μm (e.g., from 0.05 μm to 0.15 μm, from 0.07 μm to 1.1 μm, from 0.4 μm to 0.8 μm or from 0.2 μm to 1 μm). In some embodiments, a d50 particle size of the particles is in a range of from 0.2 μm to 20 μm (e.g., from 0.2 μm to 15 μm, from 0.5 μm to 20 μm, or from 1 μm to 10 μm). In some embodiments, a d10 particle size of the particles is of from 0.01 μm to 0.8 μm (e.g., from 0.02 μm to 0.1 μm, from 0.04 μm to 0.08 μm, from 0.2 μm to 0.6 μm, or from 0.1 μm to 0.7 μm). In some embodiments, a d10 particle size of the particles is of from 0.1 μm to 10 μm (e.g., from 0.1 μm to 5 μm, from 0.5 μm to 10 μm, or from 0.5 μm to 8 μm). In some embodiments, a d90 particle size of the particles is in a range of from 0.1 μm to 2 μm (e.g., 0.1 μm to 0.2 μm or 1 μm to 2 μm). In some embodiments, a d90 particle size of the particles is in a range of from 0.5 μm to 50 μm (e.g., from 1 μm to 2 μm, from 0.5 μm to 20 μm, from 10 to 30 μm). In some embodiments, particles have a d50 particle size in the range of 0.2 μm to 20 μm. In some embodiments, particles have a d10 particle size in the range of 0.1 μm to 10 μm. In some embodiments, particles have a d90 particle size in the range of 0.5 μm to 50 μm. In some embodiments, the particles are non-spherical. In some embodiments, the particles are non-spheroidal (e.g., have a length-to-thickness aspect ratio and/or a width-to-thickness aspect ratio of at least 1.2, at least 1.3, at least 1.4, at least 1.5, at least 1.6, at least 1.7, at least 1.8, at least 1.9, at least 2, at least 2.5, or at least 3). In some embodiments, the particles have a sheet-like morphology (e.g., similar to graphite) (e.g., have a platelet, disc, and/or flake morphology).

In some embodiments, the redox active material is structured to reversibly store (e.g., intercalate) ions of hydrogen (e.g., protons), ions of lithium, ions of sodium, or a combination thereof (e.g., in bulk of the redox active material). In some embodiments, the redox active material is structured such that the redox active material cannot reversibly store (e.g., intercalate) ions of potassium (e.g., in bulk of the redox active material).

The electrode composition may be included in an electrode. In some embodiments, the electrode is an anode. In some embodiments, the electrode has a density in a range of from 3.5 g/cm³ to 5.2 g/cm³ (e.g., from 4.0 g/cm³ to 4.9 g/cm³). In some embodiments, the electrode has a redox active material content of at least 90 wt % (e.g., in a range of from 90 wt % to 99 wt % or from 95 wt % to 98 wt %). In some embodiments, the electrode has a hydrophobic electrolyte-facing surface. In some embodiments, the electrode further includes a binder and/or conductive carbon. In some embodiments, the electrode further includes a titanium current collector on which the electrode composition is disposed.

The electrode may be incorporated into an electrochemical cell. In some embodiments, an electrochemical cell includes an anode (e.g., as described in the preceding paragraphs), a cathode, and an electrolyte. In some embodiments, the anode has a hydrophobic surface in contact with the electrolyte.

In some embodiments, the electrolyte is aqueous. In some embodiments, the electrolyte is acidic. In some embodiments, the electrolyte has a pH of 1-5. In some embodiments, the electrolyte has a pH of 3-4. In some embodiments, the electrolyte is a buffered electrolyte. In some embodiments, the electrolyte comprises a salt comprising aluminum, vanadium, manganese, iron, copper, zinc, gallium, or bismuth.

In some embodiments, the electrochemical cell includes a separator disposed between the anode and the cathode that prevents physical contact between the anode and the cathode.

In some embodiments, the electrochemical cell is a battery. In some embodiments, the battery is a secondary battery. In some embodiments, the battery has a cycle life of at least 50 cycles, at least 100 cycles, at least 150 cycles, at least 200 cycles, or at least 250 cycles. In some embodiments, the battery is a proton battery (e.g., wherein the proton battery is operable to reversibly store (e.g., intercalate) protons in the cathode and/or anode during charge and discharge and/or wherein the battery is operable to transport protons between the anode and the cathode during charge and discharge).

In some embodiments, the electrochemical cell has one or two working ions (e.g., monovalent, bivalent, and/or trivalent ions). In some embodiments, the one or two working ions comprise a hydrogen ion, a lithium ion, or a sodium ion. In some embodiments, the one or two working ions is two working ions comprising (i) a hydrogen ion and a lithium ion, (ii) a sodium ion and a lithium ion, or (iii) a hydrogen ion and a sodium ion. In some embodiments, the electrochemical cell is operable to reversibly store (e.g., intercalate) the one or two working ions in the cathode and/or anode during charge and discharge and/or wherein the electrochemical cell is operable to transport the one or two working ions between the anode and the cathode during charge and discharge.

Any two or more of the features described in this specification, including in this summary section, may be combined to form implementations not specifically explicitly described in this specification.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 shows a schematic illustration of host-guest chemistry of transition metal oxide redox active particles, according to illustrative embodiments of the present disclosure;

FIG. 2 shows scanning electron microscope (SEM) images of exemplary transition metal oxide (TMO) particles having different particles sizes, wherein Panel A shows particles having D₉₀=0.5 μm; Panel B shows particle having D₉₀=5 μm, and Panel C shows particles having D₉₀=20 μm, according to illustrative embodiments of the present disclosure;

FIG. 3 shows scanning electron microscope (SEM) images of exemplary transition metal oxide (TMO) particles having different particle morphology, wherein Panel A shows a plate morphology; Panel B shows a truncated octahedral morphology, and Panel C shows a secondary microsphere morphology;

FIG. 4 shows a plot of charge-discharge data of an electrochemical cell according to illustrative embodiments of the present disclosure;

FIG. 5 shows a plot of charge-discharge data of an electrochemical cell according to illustrative embodiments of the present disclosure;

FIG. 6 shows plots of cyclic voltammogram data of electrochemical cells according to illustrative embodiments of the present disclosure;

FIG. 7 shows a plot of charge-discharge data of an electrochemical cell according to illustrative embodiments of the present disclosure;

FIG. 8 shows a plot of charge-discharge data of an electrochemical cell according to illustrative embodiments of the present disclosure;

FIG. 9 shows a plot of charge-discharge data of an electrochemical cell according to illustrative embodiments of the present disclosure;

FIG. 10 shows a plot of charge-discharge data of an electrochemical cell according to illustrative embodiments of the present disclosure;

FIG. 11 shows a plot of charge-discharge data of an electrochemical cell according to illustrative embodiments of the present disclosure;

FIG. 12 shows a plot of charge-discharge data of an electrochemical cell according to illustrative embodiments of the present disclosure;

FIG. 13 shows a plot of charge-discharge data of an electrochemical cell according to illustrative embodiments of the present disclosure;

FIG. 14 shows a plot of charge-discharge data of an electrochemical cell according to illustrative embodiments of the present disclosure;

FIG. 15 shows a plot of charge-discharge data of an electrochemical cell according to illustrative embodiments of the present disclosure;

FIG. 16 shows a plot of charge-discharge data of an electrochemical cell according to illustrative embodiments of the present disclosure;

FIG. 17 shows a plot of charge-discharge data of an electrochemical cell according to illustrative embodiments of the present disclosure; and

FIG. 18 shows a plot of charge-discharge data of an electrochemical cell according to illustrative embodiments of the present disclosure.

FIG. 19 shows a plot of charge-discharge data of an electrochemical cell according to illustrative embodiments of the present disclosure.

FIG. 20 shows a plot of charge-discharge data of an electrochemical cell according to illustrative embodiments of the present disclosure.

FIG. 21 shows a plot of charge-discharge data of an electrochemical cell according to illustrative embodiments of the present disclosure.

FIG. 22 shows a plot of area capacity as a function of cycle index time for an electrochemical cell according to illustrative embodiments of the present disclosure.

FIG. 23 shows a plot of charge-discharge data of an electrochemical cell according to illustrative embodiments of the present disclosure.

### DETAILED DESCRIPTION OF CERTAIN EMBODIMENTS

Disclosed herein are inter alia electrode compositions, electrodes including said compositions, and electrochemical cells including said electrodes. Electrode compositions may include a redox active material. A redox active material may include a transition metal oxide, such as, for example a tungsten oxide. Various tungsten oxides usable in an electrode composition are disclosed. An electrode composition include particles of a redox active material, for example having a sheet-like morphology. Such electrode compositions may be included in an electrode, such as an anode. Such anodes may be incorporated in an electrochemical cell, such as a battery (e.g., a secondary battery). As described further throughout this detailed description, including in the working examples, tungsten oxide based redox active materials can be used to produce anodes having superior performance, for example in electrochemical cells such as (e.g., secondary) batteries. The following description describes many embodiments organized under different headers provided for readability, without limitation to any subject matter. Those of ordinary skill in the art will readily appreciate that one or more features described under one header may be applied to embodiments otherwise described under another header.

### Transition Metal Oxides and Associated Components as Active Electrodes for an Electrochemical Cell

In some embodiments, the present disclosure is directed toward the use of one or a combination of molybdenum, tungsten, manganese, tin, aluminum, hydrogen, and oxygen as components in TMO redox active materials. Additionally, lithium, sodium, potassium, calcium, cesium, titanium, zirconium, hafnium, vanadium, tantalum, niobium, indium, iron, zinc, cobalt, nickel, copper, tin and/or bismuth may be present as dopants, a binary alloy mixture, or intercalated atoms/ions. As an example, TMO redox active materials may comprise a general chemical formula of AₓC_{z}Oₜ or AₓB_{y}C_{z}Oₜ, where A is lithium, sodium, potassium, calcium, bismuth, hydrogen, or a combination thereof with a stoichiometry of 0≤x≤2; B is one or more selected from the group consisting of cesium, vanadium, tantalum, niobium, indium, iron, zinc, cobalt, nickel, copper, tin and strontium with a stoichiometry of 0≤y≤2; C is one or more selected from the group consisting of molybdenum, tungsten, manganese, tin, aluminum, and oxygen with a stoichiometry of 0≤z≤13; and O: oxygen with a stoichiometry of 0≤t≤48.

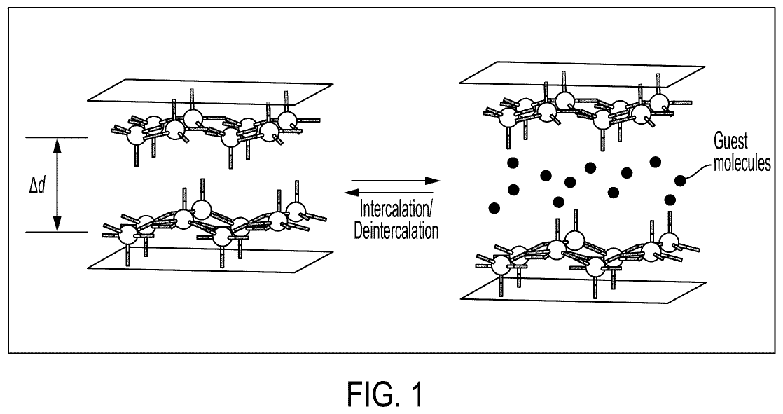

TMO redox active materials may comprise a layered crystal geometry where individual planes are stacked through the c-axis and held by weak van der Waals interlayer coupling (FIG. 1). In addition, the interlayer spacing (Δd) may be designed to accommodate several different classes of guest compounds, such as cations and/or molecules.

In some embodiments, TMO redox active particles can be prepared by combinations of any of the following methods in any order: solid-state synthesis, molten-salt synthesis, co-precipitation, sol-gel, hydrothermal, solvothermal, spray pyrolysis and/or ultrasonic spray pyrolysis. The source of metal in TMO redox particles may include, but is not limited to, one or more of the following: halides, hydroxides, oxides, phosphates, suboxides, nitrates, nitrites, sulfates, sulfides, chlorates, bromates, iodates, tungstates, molybdates, or metals of tungsten, tin, aluminum, and/or molybdenum. The source of hydrogen in TMO redox particles may be, but is not limited to, one or more of the following substances: sulfuric acid, hydrochloric acid, phosphoric acid, hydrobromic acid, hydroiodic acid, nitric acid, and/or acetic acid. The source of a second metal may be, but is not limited to, one or more of the following: chlorides, carbonates, hydroxides, nitrates, sulfates, phosphates, chlorates, bromates, iodates, tungstates, and/or molybdates of, lithium, sodium, potassium, calcium, and/or bismuth. The source of a third metal may be, but is not limited to, one or more of the following: chlorides, carbonates, hydroxides, nitrates, sulfates, phosphates, chlorates, bromates, iodates, tungstates, and/or molybdates of cesium, vanadium, tantalum, niobium, indium, iron, manganese, zinc, cobalt, nickel, copper, tin and/or strontium.

In some embodiments, chemical additives may be present to promote particle crystallinity and eliminate byproduct impurities during material preparation. Chemical additives may include, but are not limited to, chelating agents and shape directing agents. Examples of chelating agents include but are not limited to, citrate, ammonia, acetic acid, alginates, nitrilotriacetic acid, ethylenediaminetetraacetic acid, etidronic acid, aminotrimethylene phosphonic acid pentasodium salt, ethylenediamine tetra(methylene phosphonic acid) and/or combinations thereof. Examples of shape directing agents include, but are not limited to, polyvinylpyrrolidone, polystyrene colloid particles, Pluronic P123, Fluronic F127, amic acid, resol, ethylene glycol, poly(methyl methacrylate) (PMMA)-based block copolymer systems, including PMMA-b-poly(4-vinyl pyridine), PMMA b-poly(dimethyl acrylamide) (DMA) and/or PMMA-b-poly(dimethylaminoethylmethacrylate) (DMAEMA), and/or combinations thereof.

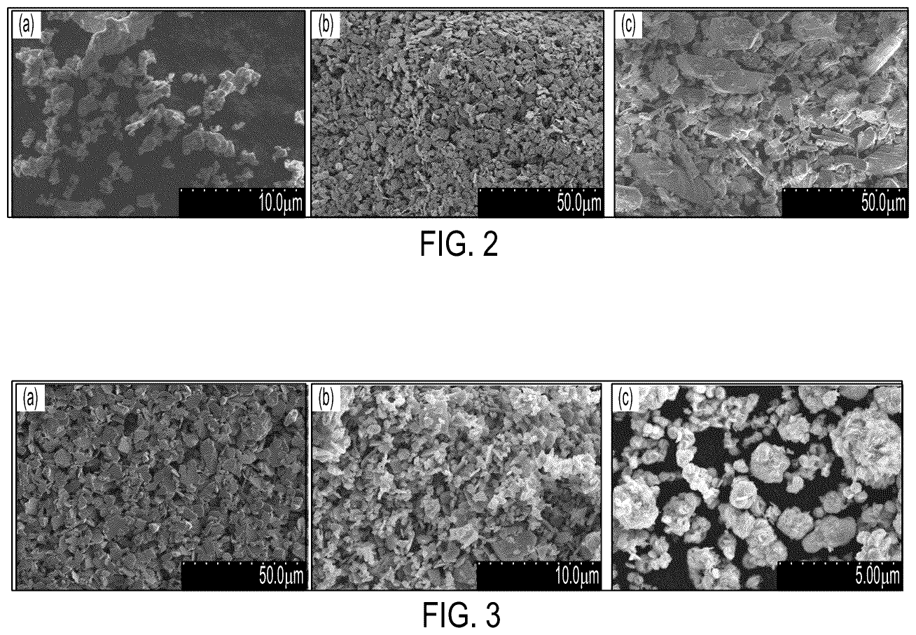

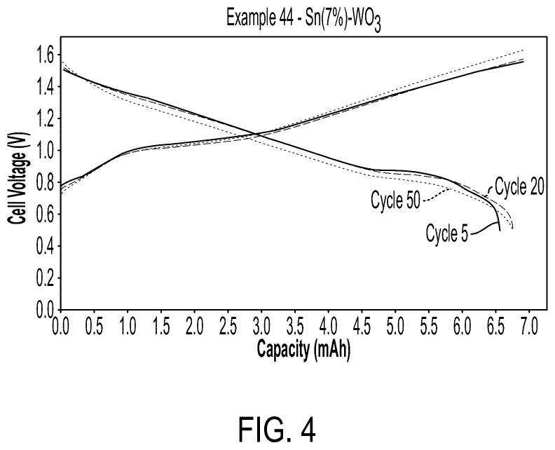

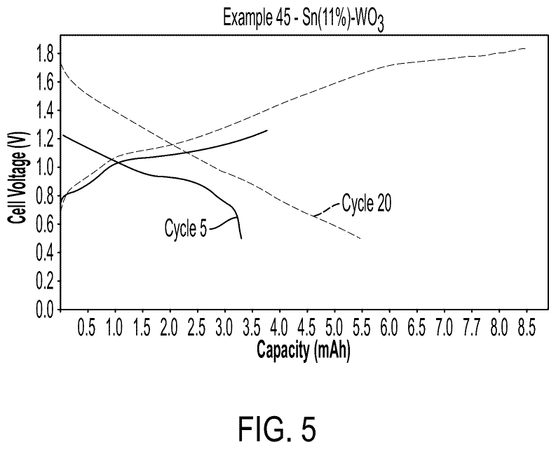

In some embodiments, TMO redox active primary particle size can be modulated from 100 nm to 50 μm (for example, between 500 nm and 20 μm). The size distribution of the particles depends on the synthetic methods and synthetic parameters including, but not limited to, molar concentration, reaction temperature and time, additives, chelating agents, and solvents (FIG. 2). In some embodiments, the morphology of TMO redox active particles may be described as platelets, truncated octahedrons, spherical agglomerates (FIG. 3), and/or combinations thereof. TMO redox active particles may be porous or non-porous.

In some embodiments, particle size, size distribution, morphology or a combination of these properties of TMO redox active primary particles are achieved through the use of temperature, pressure, or a combination of the two, in an inert environment, a gaseous environment, or in ambient or in an environmental-controlled chamber with a temperature-controlled environment (for example, a hot gaseous environment). Redox active primary particles may be processed in a liquid form and may further comprise additives (for example, a carbon precursor for carbonized TMO or a carbon-encapsulated TMO or an TMO encapsulated carbon powder; an iron oxide precursor for an iron oxide TMO composite electrode or an iron oxide encapsulated TMO or an TMO encapsulated iron oxide powder).

An electrode may be designed as an anode or a cathode in a secondary battery system. In some embodiments, an anode electrode may comprise a current collector, TMO redox active particles, conductive additives, and/or polymer additives. In some embodiments, an anode electrode may comprise a current collector, a chemical or physical combination of one or more transition metal oxides, metals, and TMO redox active particles, wherein the transition metal oxides and the metals may or may not be redox active. In some embodiments, a cathode electrode may comprise: a current collector, TMO redox active particles, conductive additives, and/or polymer additives. In some embodiments, the current collector used may comprise titanium, zirconium, aluminum, copper, nickel, carbon, stainless steel, an alloy of one or more of these components, or combinations thereof. In some embodiments, polymer additives used may include, but are not limited to, styrene-butadiene rubber, polyvinyl alcohol, poly(vinylidene fluoride), poly(tetrafluoroethylene), polyacrylic acid, poly(methyl methacrylate), carboxymethyl cellulose, carboxyethyl cellulose, hydroxyethyl cellulose, and/or hydroxypropyl cellulose.

A layered transition metal oxide may be used as a redox active material in an electrode composition (e.g., a particulate material used in or for an electrode). In some embodiments, such a redox active material may be used in a single or dual ion electrochemical cell (e.g., battery), which may be operated in aqueous or non-aqueous environment. Layered transition metal oxides, preferably having a formula of MₓW_{y}O_{z}, (where M could be one or more of, for example, H, Li, Na, K, Cs, Rb, La, Nb. Ni, Fe, Co), are capable of reversible storage (e.g., electrochemical intercalation) of one or more working ions. In some embodiments, a host structure facilitates reversible storage (e.g., intercalation) of working ions without significant structural modification during storage. In some embodiments, a reversible crystallographic phase shift of the host material MₓW_{y}O_{z} can occur during the intercalation process. In other embodiments, M_{X}W_{y}O_{z} can reversibly store (e.g., intercalate or co-intercalate) one or two different monovalent, bivalent, or trivalent ions (e.g., cations) during operation of an electrochemical cell (e.g., battery). Such ions may be or include, for example, a hydrogen ion, a lithium ion, a sodium ion, a potassium ion, a cesium ion, a magnesium ion, a calcium ion, a barium ion, a zinc ion, a copper ion, an aluminum ion. The stoichiometries represented by x, y, and z in an M_{X}W_{y}O_{z} redox active material may be between 1 and 8, preferably between 1 and 3, 1 and 5, and 1 and 8 respectively. Such reversible storage (e.g., intercalation) may occur in bulk of a redox active material, such as, for example, a transition metal oxide material (e.g., M_{X}W_{y}O_{z}).

A transition metal oxide redox active material may have a layered structure. When measured with an x-ray diffractometer using a Cu source (e.g., using x-ray powder diffraction), the resulting diffractogram for a transition metal oxide redox material (e.g., particles thereof) may show one or more major 2θ diffraction peaks. Such major peaks may include a peak in a range of 6° to 12°, a peak in a range of 16° to 22°, a peak in a range of 22° to 28°, a peak in a range of 25° to 31°, a peak in a range of 26° to 32°, a peak in a range of 31° to 37°, or a combination thereof.

Redox active material particles may have a primary particle size distribution with a d10 in a range of from 0.1 μm to 10 μm (e.g., from 0.1 μm to 5 μm or from 0.1 μm to 1 μm), a d50 in a range of from 0.2 μm to 20 μm (e.g., from 0.2 μm to 10 μm or from 0.2 μm to 2 μm), a d90 in a range of from 0.5 μm to 50 μm (e.g., from 0.5 μm to 20 μm, from 0.5 μm to 10 μm, from 1 μm to 20 μm, or from 1 μm to 10 μm), or a combination thereof. Primary particles may be aggregated to form secondary particles, for example that have a particle size distribution having a d10 in a range of from 0.5 μm to 50 μm (e.g., from 0.5 μm to 10 μm or from 0.5 μm to 5 μm), a d50 in a range of from 1 μm to 100 μm (e.g., from 1 μm to 50 μm, from 1 μm to 20 μm, from 2 μm to 100 μm, from 2 μm to 50 μm, from 10 μm to 100 μm, from 10 μm to 50 μm, or from 2 μm to 20 μm), a d90 in a range of from 2 μm to 250 μm (e.g., from 2 μm to 200 μm, from 2 μm to 150 μm, from 2 μm to 100 μm, from 5 μm to 250 μm, from 5 μm to 200 μm, from 5 μm to 150 μm, from 5 μm to 100 μm, from 6 μm to 60 μm, from 10 μm to 250 μm, from 10 μm to 200 μm, from 10 μm to 150 μm, or from 10 μm to 100 μm), or a combination thereof.

In some embodiments, primary particles may have a mean particle size in the range of micrometers. In some embodiments, primary particles have a d10 of no more than 1 μm, no more than 2 μm, no more than 5 μm, or no more than 10 μm. In some embodiments, primary particles have a d90 of no more than 10 μm, more than 20 μm, no more than 30 μm, no more than 40 μm, or no more than 50 μm. In some embodiments, primary particles have a d10 of at least 1 μm, at least 2 μm, or at least 5 μm. In some embodiments, primary particles have a d90 of at least 10 μm, at least 20 μm, at least 30 μm, or at least 40 μm. Particles of redox active material may be non-spherical. Particles of redox active material may be non-spheroidal. Particles of redox active material may have a length-to-thickness aspect ratio and/or a width-to-thickness aspect ratio of at least 1.2, at least 1.3, at least 1.4, at least 1.5, at least 1.6, at least 1.7, at least 1.8, at least 1.9, at least 2, at least 2.5, or at least 3. Particles of redox active material may have a sheet-like morphology (e.g., similar to graphite). For example, particles of redox active material may include platelets, discs, and/or flakes.

A MₓW_{y}O_{z} material may be synthesized from a perovskite type molecular precursor that includes [W_{y}O_{z}]^{y-} layers and one or more soluble cations. An ion exchange process can be used to selectively replace the soluble cation in the lattice with one or more desired cations (one or more M+ cations) present in an ion exchange solution. The pH and the reagent concentration of the ion exchange solution can be varied to obtain different stoichiometry.

In some embodiments, a redox active material (e.g., a M_{X}W_{y}O_{z} redox active material) may include structural water bonded to lattice oxygen by hydrogen bonding. Such structural water which may lead to strong interlayer hydrogen bonding. This type of interlayer hydrogen bonding may stabilize the structure during a reversible storage (e.g., bulk storage) (e.g., intercalation-deintercalation) process. In some embodiments, a redox active material may include pre-intercalated ions (e.g., cations), for example including H⁺, Li⁺, Na⁺, K⁺, Cs⁺, Rb⁺, La⁺, Cu²⁺, Ni²⁺ or a combination thereof. Such pre-intercalated ions may provide structural stability to a redox active material. In some embodiments, a transition metal oxide (e.g., M_{X}W_{y}O_{z}) of a redox active material may include oxygen vacancies. Such oxygen vacancies may have been introduced through heteroatom doping using one or more heteroatoms. Such heteroatoms may be or include Cu, Ni, Nb, Bi, In, Sn, B, Fe, Co, Mn, Zn, Al, V, Mg, Ta, La, Cs, Mo, or a combination thereof. Introducing heteroatom dopants in a host lattice of a redox active material may or may not change electronic conductivity by altering the band gap of the material, which may improve charge transfer kinetics and/or allow faster charge/discharge rate. In some embodiments, the presence of certain heteroatoms may increase the working ion diffusivity and catalytic activity of a redox active material leading to higher specific capacity and high discharge voltage. In some embodiments, the presence of heteroatoms may increase structural stability of a redox active material and prevent undesirable phase change during a charge and/or discharge process leading to longer cycle life. In some embodiments, a transition metal oxide (TMO) may be subjected to a thermal treatment in a low oxygen or oxygen free atmosphere to introduce oxygen vacancies into its crystal structure.

An electrode composition may include particles, for example M_{X}W_{y}O_{z} particles, (e.g., obtained as a powder) that are a redox active material in an electrode (e.g., an anode). In addition to a redox active material, an electrode (e.g., anode) may include a current collector, one or more conductive additives, one or more rheological additives, and/or one or more binders. In some embodiments, processing of a redox active material powder into a formed electrode is performed using one or more coating techniques (e.g., coating onto a current collector). For example, doctor blading, slot-die coating, reverse roll coating, gravure coating, knife-over-roll coating, or comma coating may be used. In some embodiments, a current collector used may be, for example, titanium, zirconium, aluminum, copper, nickel, carbon, graphite, graphene, or stainless steel (e.g., as a sheet or foil). In some embodiments, a binder used may be, for example, styrene-butadiene rubber, polyurethane, poly(vinylidene fluoride), poly(tetrafluoroethylene), sulfonated poly(tetrafluoroethylene) (Nafion), polyacrylic acid, polyurethane, or poly(methyl methacrylate). In some embodiments, a rheological modifier used may be, for example, carboxymethyl cellulose, carboxyethyl cellulose, hydroxyethyl cellulose, hydroxypropyl cellulose, polyacrylic acid, or poly(methyl methacrylate). In some embodiments, an electrode (e.g., anode) could be paired with a cathode in an electrochemical cell. A cathode includes one or more redox active cathode materials. For example, a cathode may include a nickel manganese cobalt oxide (NMC) (e.g., lithium nickel manganese cobalt oxide), a nickel cobalt aluminum oxide (NCA) (e.g., lithium nickel cobalt aluminum oxide), a lithium cobalt oxide, a manganese oxide (e.g., a lithium manganese oxide), a lithium iron phosphate (LFP), a sodium oxide (e.g., NaMO₂, M=V, Fe, Mn, Cu, Co., and/or Ni), a sodium phosphate (e.g., a sodium iron phosphate), or a transition metal oxide (e.g., V₂O₅, VO₂, V₆O₁₃, MnO₂, or Mn₃O₄), a Prussian blue analogue (PBA) (e.g., MM′(CN)₆, for example with M and M′ independently being one or more of Fe, Co, Ni, Cu, Zn, and/or Mn), or a combination thereof.

Redox active materials disclosed herein may be structured to accommodate reversible storage (e.g., insertion and removal) (e.g., intercalation) of one or more working ions in bulk of the material during operation of an electrochemical cell. A working ion may be a cation. Working ions such as, for example, hydrogen ions, sodium ions, and lithium ions may be used (individually or a combination thereof). In some embodiments, a redox active material may be unexpectedly able to reversibly store hydrogen ions, sodium ions, lithium ions, or a combination thereof but not one or more other monovalent and/or alkali metal ions, such as potassium. Such favorability of redox active materials towards some ions over others may mitigate problems that may otherwise arise from ions present in an electrolyte that are not working ions for an electrochemical cell from interfering with charge and discharge processes for the working ion(s) (e.g., the one or two working ions).

Superior performance and/or properties of an electrode, especially an anode, may be realized with particles sheet-like morphology, for example as compared to spherical or spheroidal particles. An electrode composition may be calendered (e.g., to a high density), for example onto a current collector, in order to form an electrode (e.g., an anode). In some embodiments, unexpectedly high densities may be achieved, for example when using transition metal oxide (e.g., tungsten oxide) particles having a sheet-like morphology (e.g., as flakes, platelets, and/or discs). For example, densities exceeding 3 g/cm³ may be achieved. In some embodiments, an electrode, for example including particles of transition metal oxide based redox active material (e.g., sheet-like particles) (e.g., comprising a tungsten oxide), has a density in a range of from 3.5 g/cm³ to 5.2 g/cm³ (e.g., from 4.0 g/cm³ to 4.9 g/cm³). An electrode may include a very high weight of redox active material. For example, in some embodiments, an electrode has a redox active material content of at least 90 wt % (e.g., in a range of from 90 wt % to 99 wt % or from 95 wt % to 98 wt %). It is unexpected that such high redox active material content can be achieved when using transition metal oxide (e.g., tungsten oxide) particles having a sheet-like morphology (e.g., as flakes, platelets, and/or discs). Superior performance was also unexpected realized with hydrophobic electrolyte-electrode interfaces (e.g., electrolyte-anode interfaces) using electrodes comprising transition-metal-oxide based redox active materials (e.g., as particles having sheet-like morphology).

### Modified Redox Active Materials for Electrochemical Cells

In some embodiments, the present disclosure is directed toward modified redox active materials that can be used in electrochemical cells where modified redox active materials have structural, chemical, electronic, thermal, transport, and/or electrochemical properties modified through the presence of ions incorporated into the material structure as intercalated ions or incorporated into the crystal lattice.

Modified redox active materials may include one or more selected from the group consisting of: halides, hydroxides, oxides, phosphates, oxyphosphates, suboxides, nitrates, nitrites, sulfates, sulfides, chlorates, bromates, iodates, or certain elements. Those elements may be silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, and a combination thereof. Modified redox active materials may comprise ions incorporated into the structure in interstitial sites of the host lattice or into the lattice itself. These ions may include H⁺, NH₄⁺, Li⁺, Na⁺, K⁺, Cs⁺, Rb⁺, Mg²⁺, Ca²⁺, Ti⁴⁺, Y²⁺, Mn⁴⁺, Mn³⁺, Mn²⁺, Ni⁴⁺, Ni³⁺, Ni²⁺, Fe³⁺, Fe²⁺, Ru³⁺, Cu²⁺, Cu⁺, Zn²⁺, Sn⁴⁺, Sn²⁺, Al³⁺, Nb⁵⁺, W⁶⁺, W⁵⁺, W⁴⁺, Ga³⁺, In³⁺, N³⁻, La³⁺, Ce³⁺, Ce⁴⁺, or Bi³⁺. These ions may be present in the as-synthesized material or may be incorporated via an ion exchange process in a later processing step. These modified redox active materials may be present as particles in the form of a powder or as materials comprising a composite electrode.

In some embodiments, a modified redox active material comprises ions following a modification process wherein free mobile ions present in the interstitial sites of the host inorganic compound are exchanged with different guest ions present in an ion-exchange solution that can be aqueous, non-aqueous, or a co-solvent mixture. The ion-exchange process may be performed on particles of the initial redox active material present in the form of a powder or an electrode that may comprise a current collector, redox active material particles, polymer additives, and conductive additives. Polymer additives may include, for example, polyvinylidene fluoride (PVDF), polytetrafluoroethylene (PTFE), polyvinyl alcohol, polyvinylpyrrolidone (PVP), polyvinyl acetate, polyacrylic acid, polyvinyl chloride (PVC), carboxymethyl cellulose (CMC), hydroxypropyl cellulose (HPC), hydroxyethyl cellulose (HEC), styrene butadiene rubber (SBR), or combinations thereof. Conductive additives may include carbon black, acetylene black, carbon fibers, carbon nanotubes, graphene, graphite, a fullerene, a carbon aerogel, metal flakes, metal fibers, and/or metal particles. The extent of ion exchange can be influenced by several factors including but not limited to the size of the interstitial sites, intrinsic affinity between the ion exchange sites and guest ions, steric interaction between the guest ions, and effective ionic radius of the guest ions. In some embodiments, the guest ions are weakly bonded in the host material with electrostatic interactions. In some embodiments the guest ions can be strongly adsorbed depending on the effective ionic radius of the guest ions.

In some embodiments, the ion-exchange process leads to a crystallographic phase shift of the host material to a new structure (for example, wherein the new structure may be one or more of a new crystal structure, a different phase, different inter-sheet spacings, different oxidation state, or a new orientation). The process may also have the ability to alter the electronic structure of the inorganic active materials and modify the surface states, including Bronsted and/or Lewis acidity, oxidation state, number of defects, bond angle and/or distance, and surface terminating ligands.

In some embodiments, the ion-exchange process enables the host materials to accommodate, via intercalation or other means, guest ions, such as but not limited to: H⁺, NH₄⁺, Li⁺, Na⁺, K⁺, Cs⁺, Rb⁺, Mg²⁺, Ca²⁺, Ti⁴⁺, Y²⁺, Mn⁴⁺, Mn³⁺, Mn²⁺, Ni⁴⁺, Ni³⁺, Ni²⁺, Fe³⁺, Fe²⁺, Ru³⁺, Cu²⁺, Cu⁺, Zn²⁺, Sn⁴⁺, Sn²⁺, Al³⁺, Nb⁵⁺, W⁶⁺, W⁵⁺, W⁴⁺, Ga³⁺, In³⁺, La³⁺, Ce³⁺, Ce⁴⁺, Cs⁺, or Bi³⁺. In some embodiments, the host material may have different kinds of interstitial sites, depending on its structural characteristics, in which two or more dissimilar metal ions can co-intercalate. For example, the active material may contain two different types of interstitial sites, where one could be a moderately acidic site and can be exchanged using a mild base whereas the other one is a weak acidic site and only exchangeable in a strong base. In some embodiments the molecular precursors for the ion-exchange process can be prepared by adding electrolyte salts and include strong and/or weak acids, conjugated strong and/or weak bases, guest ions, and combinations thereof. The source of guest ions that can be dissolved into solutions for H⁺ may include, but is not limited to sulfuric acid, hydrochloric acid, phosphoric acid, hydrobromic acid, hydroiodic acid, and acetic acid, among others. For solutions with NH₄⁺, guest ions may include, but is not limited to ammonium chloride, ammonium sulfate, ammonium acetate, ammonium hydroxide, or ammonium trifluoromethanesulfonate. For solutions with Li⁺ the source may include, but is not limited to: lithium chloride, lithium sulfate, lithium acetate, lithium perchlorate, lithium carbonate, lithium nitrate, lithium trifluoromethane sulfonate, lithium bis(fluorosulfonyl)imide, lithium bis(trifluoromethane sulfonyl)imide, or lithium bis(trifluoromethane sulfonyl)amide. The sources for Na⁺, K⁺, Cs⁺, Rb⁺, Mg²⁺, Ca²⁺, Ti⁴⁺, Y²⁺, Mn⁴⁺, Mn³⁺, Mn²⁺, Ni⁴⁺, Ni³⁺, Ni²⁺, Fe³⁺, Fe²⁺, Ru³⁺, Cu²⁺, Cu⁺, Zn²⁺, Sn⁴⁺, Sn²⁺, Al³⁺, Nb⁵⁺, W⁶⁺, W⁵⁺, W⁴⁺, Ga³⁺, In³⁺, La³⁺, Ce³⁺, Ce⁴⁺, and Bi³⁺ include, but are not limited to, respective chlorides, bromides, iodides, sulfates, acetates, tungstates, carbonates, perchlorates, nitrates, trifluoromethane sulfonates, bis(fluorosulfonyl)imides, bis(trifluoromethane sulfonyl)imides, and bis(trifluoromethane sulfonyl)amides. Different pH buffers of pH ranging from 0-14 can also be used as the source of the guest ions.

In some embodiments, ions such as H⁺, NH₄⁺, Li⁺, Na⁺, K⁺, Cs⁺, Rb⁺, Mg²⁺, Ca²⁺, Ti⁴⁺, Y²⁺, Mn⁴⁺, Mn³⁺, Mn²⁺, Ni⁴⁺, Ni³⁺, Ni²⁺, Fe³⁺, Fe²⁺, Ru³⁺, Cu²⁺, Cu⁺, Cs⁺, Zn²⁺, Sn⁴⁺, Sn²⁺, Al³⁺, Nb⁵⁺, W⁶⁺, W⁵⁺, W⁴⁺, Ga³⁺, In³⁺, La³⁺, Co²⁺, Ce³⁺, Ce⁴⁺, N³⁺, or Bi³⁺ may be incorporated into the host structure during synthesis of the host material. In some embodiments, the host material is synthesized via a wet chemical reaction. In some embodiments, a salt or salts comprising the ion or ions of interest are incorporated into one of the reagent solutions for the wet chemical process, are added to the process as a standalone reagent, or are dissolved and added as a standalone solution. In some embodiments, the ions may incorporate into the host material as intercalated ions or as part of the crystal lattice. The modified host material may be even further modified through an ion exchange reaction as described above. The source of H⁺ may include, but is not limited to, sulfuric acid, hydrochloric acid, phosphoric acid, hydrobromic acid, hydroiodic acid, and acetic acid, among others. Salts with NH₄⁺ ions may include, but are not limited to, ammonium chloride, ammonium sulfate, ammonium acetate, ammonium hydroxide, or ammonium trifluoromethanesulfonate. Salts with Li⁺ ions may include, but are not limited to, lithium chloride, lithium sulfate, lithium acetate, lithium carbonate, lithium perchlorate, lithium nitrate, lithium trifluoromethane sulfonate, lithium bis(fluorosulfonyl)imide, lithium bis(trifluoromethane sulfonyl)imide, or lithium bis(trifluoromethane sulfonyl)amide. Salts with Na⁺, K⁺, Cs⁺, Rb⁺, Mg²⁺, Ca²⁺, Ti⁴⁺, Y²⁺, Mn⁴⁺, Mn³⁺, Mn²⁺, Ni⁴⁺, Ni³⁺, Ni²⁺, Fe³⁺, Fe²⁺, Ru³⁺, Cu²⁺, Cu⁺, Zn²⁺, Sn⁴⁺, Sn²⁺, Al³⁺, Nb⁵⁺, W⁶⁺, W⁵⁺, W⁴⁺, Ga³⁺, In³⁺, La³⁺, Co²⁺, Ce³⁺, Ce⁴⁺, N³⁺, or Bi³⁺ ions include, but are not limited to, respective chlorides, bromides, iodides, sulfates, acetates, tungstates, carbonates, perchlorates, nitrates, trifluoromethane sulfonates, bis(fluorosulfonyl)imides, bis(trifluoromethane sulfonyl)imides, and bis(trifluoromethane sulfonyl)amides. Different pH buffers of pH ranging from 0-14 can also be used as the source of the guest ions.

The presence of certain ions incorporated into modified redox active materials may improve characteristics of the electrochemical cell comprising of electrodes having these modified materials. Improved cell characteristics include but are not limited to higher average discharge voltage, longer cycle life, higher specific capacity, improved voltaic efficiency, improved Coulombic efficiency, or improved rate capability.

### Buffer Systems for Electrochemical Cells Using Aqueous Electrolytes

In some embodiments, the present disclosure is directed toward buffer systems used in electrolytes for energy storage systems. Buffer systems are usually solutions or solution additives that resist changes in pH usually comprising weak acid, weak base, or one or more salts. Buffer systems may provide a reservoir of cations or anions which offsets changes in pH by binding or liberating hydrogen ions or other ionic species. In some embodiments, disclosed electrolytes for energy storage systems contain buffer systems as additives along with other components such as other additives, salts, and solvents. These solvents can be aqueous, non-aqueous, or aqueous/non-aqueous cosolvents. Buffer systems may act to stabilize pH changes experienced within the energy storage system during normal operation. Buffer systems may act to increase the availability of hydrogen ions in electrolytes. Buffer systems may facilitate the transfer of hydrogen ions to either or both electrodes. The presence of buffer may promote or suppress chemical/electrochemical reactions at either electrode, including but not limited to, (de)intercalation, conversion, deposition, dissolution, or plating and stripping.

Buffered electrolytes of the present disclosure may improve certain characteristics of the energy storage system. Without wishing to be bound by any particular theory, electrodes of the present disclosure (e.g., tungsten oxide-based electrodes) may have a tendency to dissolve in some pH environments. Accordingly, in some embodiments, one or more electrodes may suffer less or negligible dissolution during cycling and/or rest, thereby prolonging the system's lifespan (e.g., cycle life), for example when utilized with exemplary electrolytes of the present disclosure. Such system improvements may be due to buffer systems maintaining the pH of systems within a compatible range or forming a passivation layer on an electrode of concern. The present disclosure includes the recognition that localized pH swings that occur at an electrode/electrolyte interface (e.g., solid-electrolyte interface (SEI)) during cycling may contribute to or cause electrode dissolution, even when overall pH of the electrolyte remains relatively steady. A buffered electrolyte may mitigate such pH swings, for example due to the presence of ions contributed by one or more salts in the electrolyte that may be disposed at that electrode/electrolyte interface. In some embodiments, buffering additives may improve voltaic efficiency (e.g., round-trip efficiency) by facilitating hydrogen ion transfer to or from at least one of the electrodes. Other characteristics of the energy storage system that may be improved, alternatively or additionally, include Coulombic efficiency, self-discharge, or nominal discharge voltage.

Depending on the chemical properties of a buffer system components, they may be added to electrolytes as liquids, powders, or salts at various pHs, and/or at various temperatures to form solutions, emulsions, suspensions, slurries, or a combination.

In some embodiments, buffer systems may be added to electrolytes directly by means of combining two aqueous solutions. In some embodiments, an electrolyte may be created by addition of electrolyte salts to a commercial buffer system.

Examples of buffer system components may include but are not limited to weak acids and/or weak bases and/or one or more salts. Weak acids may include but are not limited to formic acid, gluconic acid, oxalic acid, niacin, picolinic acid, nicotinic acid, oxamic acid, oxalamide, butanedioic acid, 2-hydroxybutanedioic acid, 2-hydroxypropane-1,2,3-tricarboxylic acid, 2-hydroxypropanoic acid, 2,3-dihydroxybutanedioic acid, (2E)-but-2-enoic acid, pyridine-2-carboxylic acid, pyridine-2,6-dicarboxylic acid, acetic acid, benzoic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, lactic acid, malic acid, succinic acid, salicylic acid, citric acid, chloroacetic acid, tartaric acid, itaconic acid, mandelic acid, gluconic acid, or salts of aluminum, vanadium, manganese, iron, copper, zinc, gallium, bismuth, or any other organic acids, inorganic acids, or metal salts which liberate a metal ion possessing properties of a classical, Lewis, or Bronsted acid. Weak bases may include but are not limited to ammonia, benzoates, ethylamine, methylamine, pyridine or any other organic or inorganic materials acting as a classical, Lewis, or Bronsted base. Buffering salts may include but are not limited to any salts containing conjugate bases, including but not limited to acetate, benzoate, citrate, formate, gluconate, lactate, oxalate, tartarate, phosphate, borate, or some combination thereof. Depending on the buffer system, the same additive may act as a base, acid, conjugate base, or conjugate acid.

Buffer system components may be added to electrolytes to comprise a buffer system at a concentration that ranges, for instance, from one ppm (part per million) to 50 wt % total at different pHs and temperatures.

### Reduced Redox Active Materials for Electrochemical Cells

In some embodiments, the present disclosure is directed toward reduced redox active materials produced through chemical or electrochemical means, methods for producing chemically or electrochemically reduced redox active materials, electrodes containing chemically or electrochemically reduced redox active materials, and electrochemical cells containing chemically or electrochemically reduced redox active materials. In some embodiments, the present disclosure is directed toward solutions (e.g., reduction solutions) capable of chemically or electrochemically reducing redox active materials. In some embodiments, it may be advantageous to provide redox active materials in a state that may be referred to as reduced or partially reduced; henceforth, these are referred to as reduced redox active materials.

Reduced redox active materials may be reversibly reduced or oxidized, depending on chemical or electrochemical environment. The chemical environment may include but is not limited to phase, pH, solvent, and the presence, concentration and composition of reactive species present in the environment. The electrochemical environment may include but is not limited to electrical potential, charge imbalance, and charge (ion and electron) conductivity. Typically, the reversible reduction or oxidation of redox active materials is used to store and release energy, otherwise known as charging and discharging. Reduced redox active materials may be organic or inorganic compounds. Inorganic reduced redox active materials may be selected from the group consisting of: halides, hydroxides, oxides, phosphates, oxyphosphates, suboxides, nitrates, nitrites, sulfates, sulfides, chlorates, cyanides, bromates, iodates, or elemental forms of a metal. The metal may be silicon, titanium, vanadium, chromium, manganese, magnesium, lithium, sodium, potassium, iron, cobalt, nickel, copper, zinc, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, and a combination thereof.

In some embodiments reduced redox active materials have the chemical formula AₓM_{y}O_{z}; where M is one or more metals from the group containing: manganese, vanadium, iron, tungsten, molybdenum, titanium, or tin; A is one or more elements from the group containing: hydrogen, lithium, sodium, potassium, magnesium, calcium, zinc or aluminum; O is one or more functional groups consisting of halides, hydroxides, oxides, phosphates, oxyphosphates, suboxides, nitrates, nitrites, sulfates, sulfides, cyanides, chlorates, bromates, and/or iodates; y≥1, z≥1 and x is a value necessary to charge balance the reduced active material. In some embodiments A may be an element that can reversibly (de)intercalate into redox activate material.

In some embodiments reduced redox active materials have the chemical formula AₜMₓN_{y}O_{z}; where M is one or more metals from the group containing: manganese, vanadium, iron, tungsten, molybdenum, titanium, or tin; N is any combination of elements selected from periodic table Groups 1 through 15; A is one or more elements from the group containing: hydrogen, lithium, sodium, potassium, magnesium, calcium, zinc or aluminum; O is one or more functional groups selected from the group consisting of halides, hydroxides, oxides, phosphates, oxyphosphates, suboxides, nitrates, nitrites, sulfates, sulfides, chlorates, bromates, and iodates; x≥1, z≥1, y<x and t is a value necessary to charge balance the reduced active material. In some embodiments A may be an element that can reversibly intercalate into redox activate material.

In some embodiments reduced redox active materials may be provided in any number of forms including but not limited to powders, films, or gels. In some embodiments reduced redox active materials are provided as particles. Particles may be provided in any shape or morphology including but not limited to spheres, rods, prisms, needles, cubes, discs, platelets, flakes.

Reduced redox active materials of the present disclosure are used to produce electrodes for electrochemical cells. In some embodiments, electrodes comprise reduced redox active materials. These electrodes may include: current collectors, polymer additives, conductive additives, and/or miscellaneous additives. In some embodiments, reduced redox active materials may be formed prior to preparation of electrodes, or formed in situ from an electrode that contains redox active material.

An electrode may include primary particles of a redox active material, for example including a transition metal oxide such as, for example, a tungsten oxide. In some embodiments, primary particles may have a mean particle size that is in the range of 50-500 nm, for example a d10 in the range of 30 nm to 300 nm (e.g., about 30 nm, about 40 nm, about 50 nm, about 60 nm, about 70 nm, about 80 nm, about 90 nm, about 100 nm, about 150 nm, about 200 nm, about 250 nm, or about 300 nm), a d90 in the range of 75 nm to 950 nm (e.g., about 75 nm, about 80 nm, about 90 nm, about 100 nm, about 150 nm, about 200 nm, about 250 nm, about 300 nm, about 350 nm, about 400 nm, about 450 nm, about 500 nm, about 550 nm, about 600 nm, about 650 nm, about 700 nm, about 750 nm, about 800 nm, about 850 nm, about 900 nm, about 950 nm) and a d99.9 less than about 1 μm. In some embodiments, primary particles may have a mean particle size in the range of micrometers. In some embodiments, primary particles have a d10 of no more than 1 μm, no more than 2 μm, no more than 5 μm, or no more than 10 μm. In some embodiments, primary particles have a d90 of no more than 10 μm, more than 20 μm, no more than 30 μm, no more than 40 μm, or no more than 50 μm. In some embodiments, primary particles have a d10 of at least 1 μm, at least 2 μm, or at least 5 μm. In some embodiments, primary particles have a d90 of at least 10 μm, at least 20 μm, at least 30 μm, or at least 40 μm. Particles of redox active material may be non-spherical. Particles of redox active material may be non-spheroidal. Particles of redox active material may have a length-to-thickness aspect ratio and/or a width-to-thickness aspect ratio of at least 1.2, at least 1.3, at least 1.4, at least 1.5, at least 1.6, at least 1.7, at least 1.8, at least 1.9, at least 2, at least 2.5, or at least 3. Particles of redox active material may have a sheet-like morphology (e.g., similar to graphite). For example, particles of redox active material may include platelets, discs, and/or flakes.

Methods of producing reduced redox active material via chemical means are described. In some embodiments, the initial redox active material particles or an electrode comprising these particles may be treated with a reduction solution to form reduced redox active materials. Reduction solutions may comprise one or more solvents, one or more reducing agents, and one or more of any number of acids, any number of bases, and/or any number of cationic species. In some embodiments the solvent may be one of or a mixture of: water, alcohols, esters, aliphatic solvents or aromatic solvents. In some embodiments the reducing agent may include one or materials selected from the following: halides, hydroxides, oxides, phosphates, phosphites, suboxides, nitrates, nitrites, sulfates, sulfides, chlorates, bromates, bromides, iodates, iodides, borohydrides, aluminum hydrides, bis(2-methoxyethoxy)aluminum hydrides, thiosulfates, dithionates, or elemental forms of a metal where the metal may be lithium, sodium, potassium, rubidium, magnesium, calcium, strontium, iron, copper, lead, zinc, aluminum, gallium, indium, tin, or chromium, or organic compounds such as oxalic acid, formic acid, or ascorbic acid. These materials may be in the form of powders, foils, dissolved solutions, and/or mixed eutectic alloys.

In some embodiments, reduction solutions may contain ions such as, but not limited to, H⁺, Li⁺, Na⁺, K⁺, Mg²⁺, Ca²⁺, Zn²⁺, and/or Al³⁺ that are capable of intercalating into the reduced redox active material during the reduction process.

In some embodiments, the present disclosure is directed to reduction solutions for producing reduced redox active materials, which may be prepared by adding commercially available electrolyte salts, in a manner familiar to a person having ordinary skill in the art. Any number of salts may be used to provide the ions. In some embodiments the source of the ions can be any number of acids, bases or salts. These acids, bases, or salts may include but are not limited to: sulfuric acid, hydrochloric acid, phosphoric acid, hydrobromic acid, hydroiodic acid, acetic acid, lithium sulfate, lithium acetate, lithium perchlorate, lithium nitrate, lithium trifluoromethane sulfonate, lithium bis(fluoro sulfonyl)imide, lithium bis(trifluoromethane sulfonyl)imide, lithium bis(trifluoromethane sulfonyl)amide, sodium sulfate, sodium scetate, sodium perchlorate, sodium nitrate, sodium trifluoromethane sulfanorate, sodium bis(fluoro sulfonyl)imides, sodium bis(trifluoromethan sulfonyl)imide, sodium bis(trifluoromethan sulfonyl)amide, potassium sulfate, potassium acetate, potassium perchlorate, potassium nitrate, potassium trifluoromethane sulfonate, potassium bis(fluoro sulfonyl)imides, potassium bis(trifluoromethane sulfonyl) imide, potassium bis(trifluoromethan sulfonyl)amide, magnesium sulfate, magnesium acetate, magnesium perchlorate, magnesium nitrate, magnesium trifluoromethane sulfonate, magnesium bis(fluoro sulfonyl)imides, magnesium bis(trifluoromethane sulfonyl) imide, magnesium bis(trifluoromethan sulfonyl) amide, calcium sulfate, calcium acetate, calcium perchlorate, calcium nitrate, calcium trifluoromethane sulfonate, calcium bis(fluoro sulfonyl) imides, calcium bis(trifluoromethane sulfonyl) imide, calcium bis(trifluoromethane sulfonyl) amide, zinc sulfate, zinc acetate, zinc perchlorate, zinc nitrate, zinc trifluoromethane sulfonate, zinc bis(fluoro sulfonyl) imides, zinc bis(trifluoromethane sulfonyl) imide, zinc bis(trifluoromethan sulfonyl) amide, aluminum sulfate, aluminum acetate, aluminum perchlorate, aluminum nitrate, aluminum trifluoromethane sulfonate, aluminum bis(fluoro sulfonyl) imides, aluminum bis(trifluoromethane sulfonyl) imide, and/or aluminum bis(trifluoromethane sulfonyl) amide. In some embodiments, these ions may intercalate into the structure of the reduced redox active materials during the reduction process.

In some embodiments, reduced redox active materials may be electrochemically formed from an electrode comprising redox active material. A redox active material electrode is an electrode for an electrochemical cell that may include an electrically conductive current collector, at least one redox active material, polymer additives, conductive additives, and/or miscellaneous additives. To carry out these embodiments, an electrochemical cell is constructed from at least a redox active material electrode, a counter electrode, and an electrolyte. Redox active materials are converted to reduced redox active materials by applying an electrical potential in the range of −0.1 to −1.8 V vs. Ag/AgCl. As an example, in a cell construction wherein both an as-synthesized anode and cathode are in an oxidized state, one of the anode or cathode may be reduced as part of this procedure. Another example would cover a cell construction wherein both an as-synthesized anode and cathode are in a reduced state, and one of the anode or cathode may be oxidized as part of this procedure. Reduced redox active materials obtained in this manner may then be used as is. Electrolytes comprise a reduction solution. Electrolytes may additionally comprise one or more of the following: dissolved metal salts, acids or bases, pH buffers, redox mediators, and water. The acids of the of electrolytes may include but are not limited to hydrochloric acid, sulfuric acid, nitric acid, acetic acid, benzoic acid, formic acid, gluconic acid, oxalic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, pyridine-3-carboxylic acid, pyridine-3,5-dicarboxylic acid, pyridine-4-carboxylic acid, (methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, salts of aluminum, vanadium, manganese, iron, copper, zinc, sodium, lithium, gallium, bismuth, or any other organic acids, inorganic acids, or metal salts which liberate a metal ion possessing properties of a classical, Lewis, or Bronsted acid. The bases of electrolytes may include but are not limited to alkali or alkaline hydroxides, ammonia, benzoates, ethylamine, methylamine, pyridine or any other organic or inorganic materials acting as a classical, Lewis, or Bronsted base.

The process can be completed either in-situ or ex-situ. In some embodiments, after the electrochemical reduction process is complete, reduction solutions may be removed from electrodes via rinsing with a material such as water, organic solvent, or additional electrolyte of the same or different composition prior to further processing.

In some embodiments a redox active material electrode roll is passed through a bath containing a reduction solution with a counter electrode, a negative potential is applied, and then rewound in a roll-to-roll process. In some embodiments, stamped electrode sheets are arranged in a magazine and introduced to a bath containing a reduction solution where a negative potential is applied opposite a counter electrode in a batch process. In some embodiments, the pre-charged electrode rolls or sheets are processed and assembled into full cells which are then filled with electrolyte prior to cycling.

In some embodiments, a complete battery cell is filled with a reduction solution and undergoes a reduction step prior to cycling where electrons are transferred from the opposing electrode in the cell, or a third electrode in the cell that will not be involved in subsequent cell operation, to drive the target electrode to a partially or fully reduced state. In some embodiments, reduction solutions may be removed, potentially via a rinsing method, and an additional dose of electrolyte may be introduced to the cell prior to final assembly and operation. In some embodiments, a reduction solution is not removed, and more electrolyte is added to the cell without a rinsing step. In some embodiments, a reduction solution is removed and replaced by a new electrolyte solution with a different composition from the original reduction solution.

In some embodiments, reduced redox active materials described herein may also be produced through thermal processes (for example, through heat treatments in reducing atmospheres such as hydrogen and/or carbon monoxide).

In some embodiments, the present disclosure is directed to oxidized redox active materials produced through chemical, electrochemical, or thermal means and solutions capable of chemically, electrochemically, or thermally oxidizing redox active materials, referred to as “oxidation solutions”.

### Aqueous Electrochemical Cells

As presented herein, electrochemical cells (e.g., aqueous electrochemical cells) may comprise a positive electrode (e.g., a cathode), a negative electrode (e.g., an anode), a separator disposed between an anode and a cathode to physically and electrically isolate the two electrodes, and an electrolyte. An electrochemical cell comprises an electrolyte containing a weak acid and at least one electrode that stores/releases positively charged hydrogen ions as charge carriers during cycling.

In some embodiments, electrodes comprise a redox active material, polymer additives, and/or conductive additives applied to a conductive substrate, also called a current collector. Redox active materials on either a cathode or an anode may include one or more selected from the group consisting of: halides, hydroxides, oxides, cyanides, phosphates, oxyphosphates, suboxides, nitrates, nitrites, sulfates, sulfides, chlorates, bromates, iodates, or elemental forms of a metal. The metal may be silicon, titanium, vanadium, chromium, manganese, magnesium, lithium, sodium, potassium, iron, cobalt, nickel, copper, zinc, germanium, aluminum, gallium, zirconium, niobium, molybdenum, ruthenium, silver, cadmium, indium, tin, antimony, lanthanum, cerium, neodymium, tantalum, tungsten, rhenium, platinum, gold, lead, strontium, bismuth, mercury, and a combination thereof. In some embodiments, a redox active material is present in the form of particles.

In some embodiments, redox active materials comprise a polymer capable of storing and releasing ions during electrochemical cycling. In some embodiments, a redox active material is present partially or fully as dissolved ions in electrolytes capable of undergoing a deposition/dissolution process to store charge on either an anode or cathode, or both, during cycling. In some embodiments, a cathode redox active material contains manganese, vanadium, or iron. In some embodiments, an anode redox active material contains tungsten, zinc, molybdenum, tin, or titanium. Polymer additives may include, for example, polyvinylidene fluoride (PVDF), polytetrafluoroethylene (PTFE), polyvinyl alcohol, polyacrylic acid, alginates, polyamides, polyimides, polyesters, polyalkyds, polyacrylates, polyurethanes, acrylonitriles, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), and/or styrene butadiene rubber (SBR). Conductive additives may include carbon black, acetylene black, carbon fibers, carbon nanotubes, graphene, graphite, a fullerene, a carbon aerogel, metal flakes, metal fibers, and/or metal particles. In many embodiments, at least one of electrodes stores and releases positively charged hydrogen ions during electrochemical cycling.

### Separators

Separators may comprise one or more members selected from the group consisting of aniline, polyaniline, polypyrrole, polythiophene, polyethylene, polypropylene, polyethersulfone, sulfonated tetrafluoroethylene (Nafion), perfluorosulfonic acid, cellulose, sodium, lithium, potassium, calcium, manganese, magnesium, neodymium, praseodymium, yttrium, europium, gadolinium, scandium, aluminum, an aluminum oxide, tin, a tin oxide, titanium, a titanium oxide, a titanium carbide, silicon, a silicon oxide, a silicon carbide, a silicon nitride, a silicon aluminum oxynitride, zinc, a zinc oxide, iron, ferrites, cerium, a cerium oxide, hydrogen, water molecules, lanthanum, a lanthanum oxide, tungsten, a tungsten carbide, boron, a boron oxide, a boron nitride, zirconium, a zirconium oxide, a compound of composition M_{y}AlₓSi₁₋ₓO₂·zH₂O, where M is a metal, or a combination thereof. Separators may be a freestanding film disposed between the two electrodes or may be an electrically insulating film applied to the surface of one or both electrodes. In some embodiments, the film may comprise particles or fibers along with polymer additives such as, for example, polyvinylidene fluoride (PVDF), polytetrafluoroethylene (PTFE), polyvinyl alcohol, polyvinylpyrrolidone (PVP), polyvinyl acetate, polyvinyl chloride (PVC), carboxymethyl cellulose (CMC), hydroxypropyl cellulose (HPC), hydroxyethyl cellulose (HEC), styrene butadiene rubber (SBR).

### Electrolytes

In some embodiments, an electrolyte in an electrochemical cell (e.g., battery) is a medium that enables movement of only one working ion or of multiple working ions between a cathode and an anode. In some embodiments, electrolytes comprise water. Electrolytes may contain dissolved salts or organic cosolvents. In some embodiments, electrolytes have a pH of 7 or less, preferably less than 4. In some embodiments, electrolytes contains a material capable of acting as a weak Bronsted-Lowry or Lewis acid. Weak acids may include but are not limited to formic acid, gluconic acid, oxalic acid, niacin, picolinic acid, oxamic acid, oxalamide, butanedioic acid, 2-hydroxybutanedioic acid, 2-hydroxypropane-1,2,3-tricarboxylic acid 2-hydroxypropanoic acid, 2,3-dihydroxybutanedioic acid, (2E)-but-2-enoic acid, pyridine-2-carboxylic acid, pyridine-2,6-dicarboxylic acid, acetic acid, benzoic acid, pyridine-3-carboxylic acid, pyridine-3,5-dicarboxylic acid, pyridine-4-carboxylic acid,(methylamino)acetic acid, (dimethylamino)acetic acid, pyridine-2-sulfonic acid, pyridine-3-sulfonic acid, pyridin-2-ylmethylamine, pyridin-3-ylmethylamine, amino(oxo)methanesulfonic acid, 2-oxo-2-(phenylamino)acetic acid, N1-phenyloxalamide, oxo(phenylamino)methanesulfonic acid, L-Arginine, L-Histidine, L-Alanine, L-Proline, aminoacetic acid, phosphoric acid, boric acid, or salts of aluminum, vanadium, manganese, iron, copper, zinc, gallium, bismuth, or any other organic acids, inorganic acids, or metal salts which liberate a metal ion possessing properties of a classical, Lewis, or Bronsted acid.

In some embodiments, an aqueous electrolyte is used in an electrochemical cell. In some embodiments, one or more solvents used in an electrolyte may be organic in nature, where examples include, but are not limited to: ethanol, isopropanol, methanol, sulfolane, Diethyl ether, N-methylpyrrolidone, acetonitrile, N,N-dimethylformamide, N,N-dimethylacetamide, tetrahydrofuran, ethylene carbonate, dimethyl carbonate, diethyl carbonate, gamma butyrolactone, fluoroethylene carbonate, vinylene carbonate, and propylene carbonate. In some embodiments, an electrolyte may contain an organic salt, an inorganic salt, or a combination of one or more organic salts and one or more inorganic salts. An electrolyte salt may include one or more cations such as, for example, an ion including lithium, sodium, potassium, aluminum, cesium, magnesium, calcium, barium, zirconium, vanadium, chromium, molybdenum, tungsten, manganese, iron, cobalt, iridium, nickel, copper, silver, gold, zinc, phosphonium, ammonium, tetraalkylammonium, imidazolium, pyridinium, isoquinolinium, or a combination thereof. An electrolyte salt may include one or more anions, such as, for example an ion including a sulfate, a sulfonate, a phosphate, an acetate, a formate, a nitrate, a hexavalent phosphate, a hydroxide, a fluoride, a chloride, a bromide, an iodide, a trifluoromethanesulfonate, a bis(trifluoromethane)sulfonimide, or a combination thereof. In some embodiments, an electrolyte may contain one, or a combination of multiple, proton donor materials such as, for example, nitric acid, hydrochloric acid, hydrobromic acid, hydroiodic acid, glacial acetic acid, sulfuric acid, formic acid, 2-thiopehencarboxylic acid, 3-thiopehencarboxylic acid, 2-picolinic acid, 3-nitcotinic acid, benzoic acid, terephthalic acid, isoterephthalic acid, 2-furoic acid, 3-furoic acid, p-toluenesulfonic acid, 2-pyridinesulfonic acid, 3-pyridinesulfonic acid, 2-picolinamide, 3-nitcotinamide, 2-amino-2-oxoacetic acid, D/L-Alanine, D/L-Arginine, D/L-Proline, glycine, sarcosine, or a combination thereof. In some embodiments, an electrolyte may contain one or more proton acceptor materials such as, for example, sodium hydroxide, potassium hydroxide, lithium hydroxide, ammonium hydroxide, manganese hydroxide, calcium hydroxide, pyridine, piperdine, a methoxide, a tert-butoxide, ammonium, an alkylamine, a dialkylamine, a trialkylamine, an arylamine, a diarylamine, a triarylamine, or a combination thereof.

### Aqueous Electrochemical Cell Cycling

Without wishing to be bound by any particular theory, an exemplary electrochemical cell may operate as presented herein. Upon discharge, an electron, or electrons are displaced from an active anode material and transferred to an active cathode material. Concurrently, charge storage ions may de-intercalate from an active anode material and intercalate into a cathode active material. Upon charge, an electron is displaced from an active cathode material and transferred to an active anode material. Concurrently, charge storage ions may de-intercalate from an active cathode material and intercalate into an anode active material. Intercalation is defined as charge storage within an active material and de-intercalation is defined as and ion leaving an active material.

### EXEMPLIFICATION

The following examples embody certain methods, compositions, and electrochemical cells of the present disclosure and demonstrate fabrication of exemplary electrodes, according to certain embodiments described herein. Moreover, the following examples are included to demonstrate principles of disclosed compositions and methods and are not intended as limiting.

### Example #1

Lithium titanate (Li₄Ti₅O₁₂) powder was used as obtained. The powder had a d10 of 5.3 μm, d50 of 13.2 μm and a d90 of 55.9 μm.

### Example #2

Molybdenum (VI) oxide (MoO₃) powder was used as obtained. The powder had a d10 of 3.7 μm, d50 of 7.9 μm and a d90 of 14.8 μm.

### Example #3

Tin (IV) oxide (SnO₂) powder was used as obtained. The powder had a d10 of 0.2 μm, d50 of 1.3 μm and a d90 of 8.0 μm.

### Example #4

Bismuth vanadium oxide (BiVO₄) powder was used as obtained. The powder had a d10 of 5.2 μm, d50 of 17.2 μm and a d90 of 58.5 μm.

### Example #5

Tungsten (VI) oxide (WO₃) powder was used as obtained. The powder had a d10 of 0.7 μm, d50 of 10.5 μm and a d90 of 86.9 μm.

### Example #6

Tungsten (VI) oxide (WO₃) powder was used as obtained. The powder had a d10 of 12.3 μm, d50 of 99.5 μm and a d90 of 194.0 μm.

### Example #7

The powder from Example #6 was milled in a stirring ball mill. The milled powder had a d10 of 0.06 μm, d50 of 0.09 μm and a d90 of 0.14 μm.

### Example #8

The particles from Example #7 were spray dried. When spray dried, a secondary particle comprising primary particles was observed. The spray dried powder had a secondary particle size distribution of d10: 3.7 μm, d50: 6.2 μm and d90: 10.0 μm. The primary particle size distribution was d10: 0.06 μm, d50: 0.09 μm and d90: 0.14 μm.

### Example #9

Manganese tungstate (MnWO₄) powder was used as obtained. The powder had a d10 of 7.0 μm, d50 of 18.9 μm and a d90 of 47.2 μm.

### Example #10

Powder comprising WO₃ doped with 7% Sn was used as obtained. The powder had a d10 of 0.2 μm, d50 of 28.2 μm and a d90 of 125 μm.

### Example #11

Powder comprising WO₃ doped with 11% Sn was used as obtained. The powder had a d10 of 2.0 μm, d50 of 29.7 μm and a d90 of 165.4 μm.

### Example #12

H₂W₂O₇ powder was produced in a wet chemical process. The crystal structure of the material can be described as a layered structure. When measured with an x-ray diffractometer using a Cu source, the diffractogram showed several major peaks in 2θ, including a first peak in the range of 6° to 12°, a second peak in the range of 16° to 22°, a third peak in the range of 22° to 28°, a fourth peak in the range of 25° to 31°, and a fifth peak in the range of 31° to 37°. The powder had a d10 of 0.6 μm, d50 of 1.3 μm and a d90 of 2.8 μm.

### Example #13—Li₄Ti₅Oi₂

The powder from Example #1 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.8 g/cm³ using a calender press.

### Example #14—MoO₃

The powder from Example #2 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was unmodified.

### Example #15—SnO₂

The powder from Example #3 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.5 g/cm³ using a calender press.

### Example #16—BiVO₄

The powder from Example #4 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.2 g/cm³ using a calender press.

### Example #17

The powder from Example #5 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 2 g/cm³ using a calender press.

### Example #18—WO₃

The powder from Example #8 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 3.9 g/cm³ using a calender press.

### Example #19—MnWO₄

The powder from Example #9 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.7 g/cm³ using a calender press.

### Example #20-7% Sn WO₃

The powder from Example #10 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.5 g/cm³ using a calender press.

### Example #21-11% Sn-doped WO₃

The powder from Example #11 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 1.2 g/cm³ using a calender press.

### Example #22—H₂W₂O₇

The powder from Example #12 was combined with conductive carbon, water, styrene butadiene rubber, and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 3.7 g/cm³ using a calender press.

### Example #23

WO₃*0.6H₂O powder as produced in a hydrothermal chemical process. The crystal structure of the material can be described as a hexagonal crystal structure with major peaks in 2θ including first peak in the range of 10° to 15° (about 14°), four peaks between 20° to 30°, and a sixth peak between 32° and 38° (about 36°).

### Example #24—WO₃*0.6H₂O

The powder from Example #23 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4%-dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched or stamped to any 2-dimensional shape or form factor for cell construction. The density of the electrode was modified to 2.42 g/cm³ using a calender press.

### Example #25—WO₃*0.6H₂O

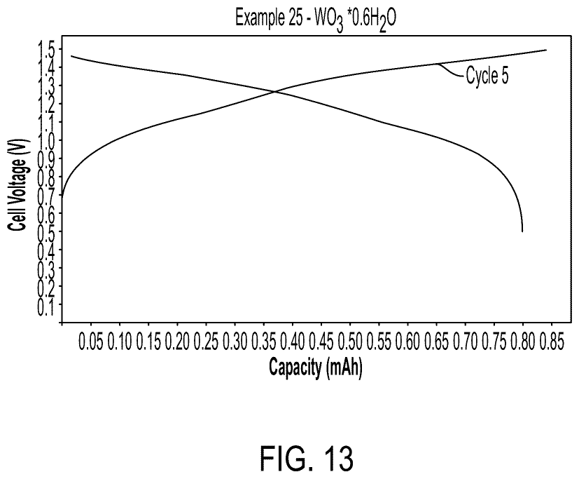

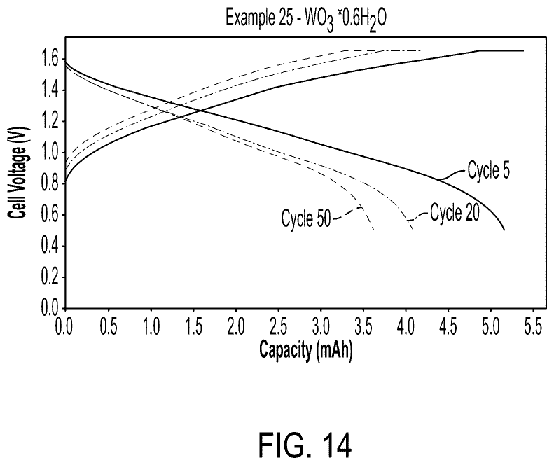

The electrode of Example #24 was used in the construction of cells as an anode. The cell was arranged with a layer of the exemplary electrode, a separator, and counter-electrode. The counter-electrode was manganese dioxide coated on a titanium current collector. The cells were cycled at C/5, D/5. Discharge voltage, capacity, roundtrip efficiency, Coulombic efficiency recorded for cycle 5 and cycle 50 and presented in the tables in Example #47. Plots of charge-discharge data for this example are shown in FIG. 13 and FIG. 14.

### Example #26

Mn₂O₃ powder as produced by a coprecipitation synthesis method. The crystal structure of the material can be described as a cubic structure. The diffractogram showed several major peaks in 2θ, including a first peak in the range of 20° to 25° (about 23.1°), a second peak in the range of 30° to 35° (about 32.5°), a third peak in the range of 35° to 40° (about 38.2°), a fourth peak in the range of 40° to 46° (about 45.2°), and a fifth peak in the range of 52° to 57° (about 55.2°).

### Example #27—Mn₂O₃

The powder from Example #26 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4%-dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched or stamped to any 2-dimensional shape or form factor for cell construction.

### Example #28—Mn₂O₃

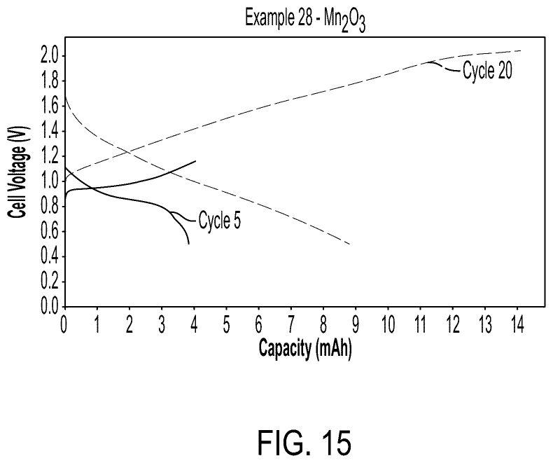

The electrode of Example #27 was used in the construction of cells as a cathode. The cell was arranged with a layer of the exemplar electrode, a separator, a mildly acidic aqueous buffered electrolyte, and counter-electrode. The counter-electrode was tungsten (VI) oxide or tungsten trioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 15.

### Example #29

a-MnO₂ powder was used as obtained.

### Example #30—a-MnO₂

The powder from Example #29 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4%-dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched or stamped to any 2-dimensional shape or form factor for cell construction. The density of the electrode was modified to 1.6 g/cm³ using a calender press.

### Example #31—a-MnO₂

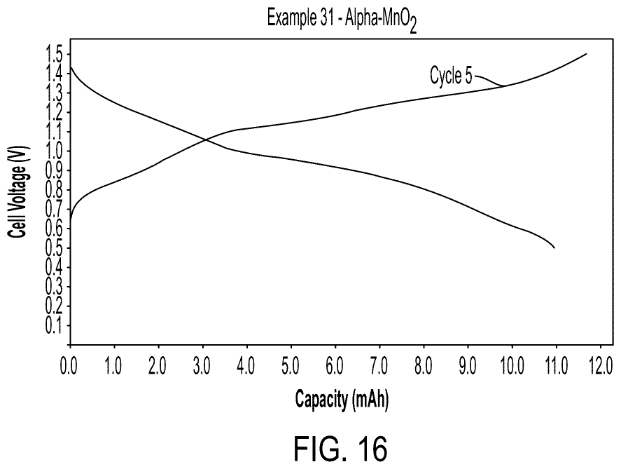

The electrode of Example #30 was used in the construction of cells as a cathode. The cell was arranged with a layer of the exemplar electrode, a separator, a mildly acidic aqueous buffered electrolyte and counter-electrode. The counter-electrode was tungsten (VI) oxide or tungsten trioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 16.

### Example #32

a-KMnO₂ powder was produced by a hydrothermal synthesis method. The crystal structure of the material can be described as a tetragonal structure with major peaks in 2θ including the first peak in the range of 10° to 15° (about 12.78°), and second major peak at 15° to 20° (about 18°), and a third major peak at 25° to 30° (about 28°), and a fourth major peak at 35° to 40° (about 37.5°).

### Example #33—a-KMnO₂

The powder from Example #32 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4%-dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched or stamped to any 2-dimensional shape or form factor for cell construction. The density of the electrode was modified to 2.23 g/cm³ using a calender press.

### Example #34—a-KMnO₂

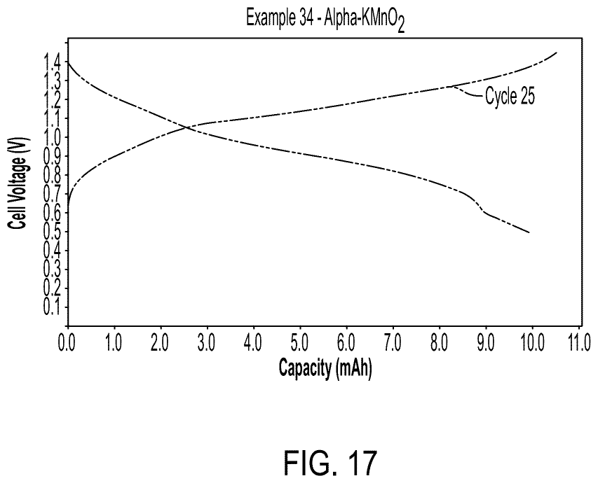

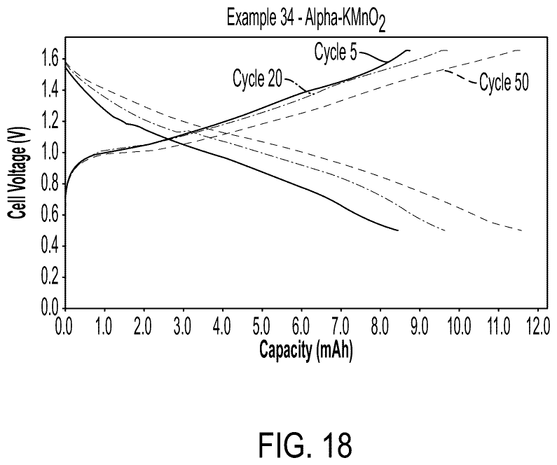

The electrode of Example #33 was used in the construction of cells as a cathode. The cell was arranged with a layer of the exemplar electrode, a separator, a mildly acidic aqueous buffered electrolyte and counter-electrode. The counter-electrode was tungsten dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. Plot of charge-discharge data for this example are shown in FIG. 17 and FIG. 18.

### Example #35

Ta₂O₅ powder was used as obtained.

### Example #36—Ta₂O₅

The powder from Example #35 was combined with conductive carbon, water, styrene butadiene rubber and sodium-carboxymethyl cellulose to a titanium current collector. The exemplar powder was added at approximately 90%, the conductive carbon was added at approximately 4%, the styrene butadiene rubber was added at approximately 4%-dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched or stamped to any 2-dimensional shape or form factor for cell construction.

### Example #37—Ta₂O₅

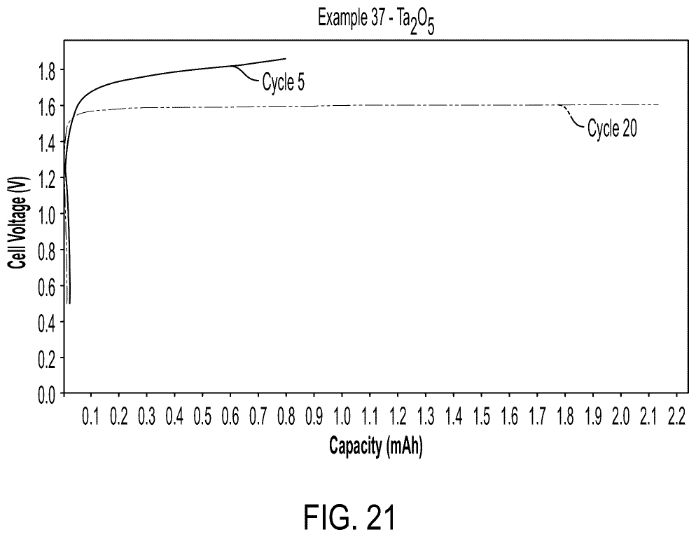

The electrode of Example #36 was used in the construction of cells as an anode. The cell was arranged with a layer of the exemplar electrode, a separator, a mildly acidic aqueous buffered electrolyte and counter-electrode. The counter-electrode manganese dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 21.

### Example #38—Li₄Ti₅O₁₂

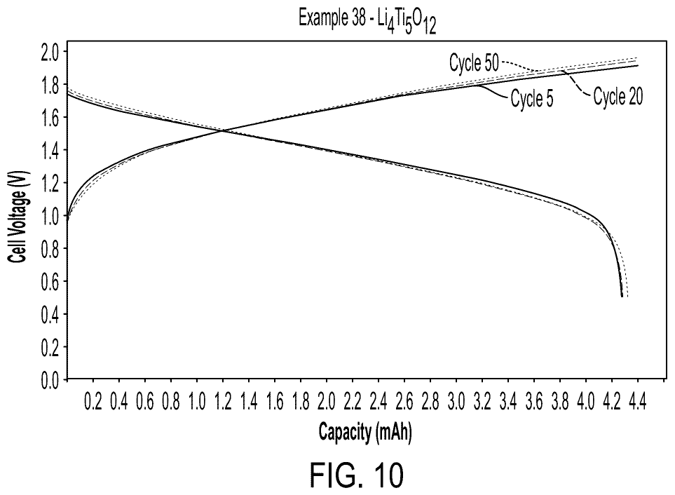

The electrode of Example #13 was used in the construction of cells as an anode. The cell was arranged with a layer of the exemplar electrode, a separator, a mildly acidic aqueous buffered electrolyte and counter-electrode. The counter-electrode manganese dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 10.

### Example #39—MoO₃

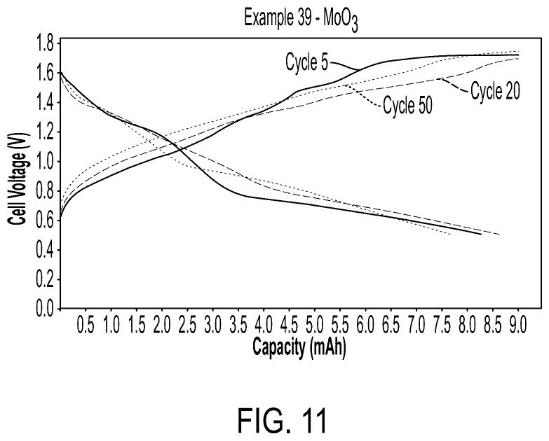

The electrode of Example #14 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 11.

### Example #40—SnO₂

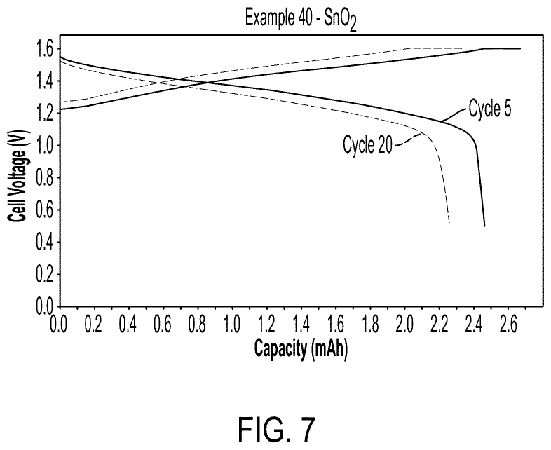

The electrode of Example #15 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 7.

### Example #41—BiVO₄

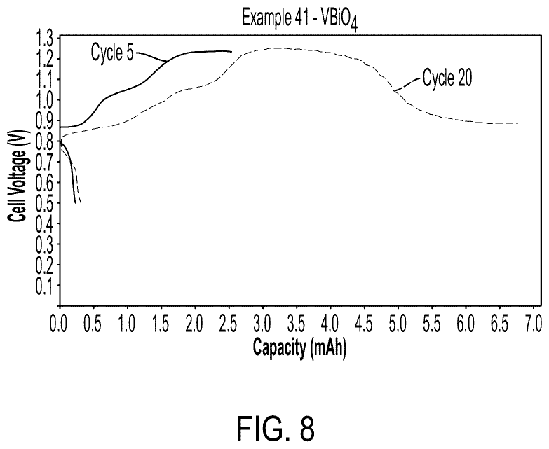

The electrode of Example #16 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/10, D/10. Discharge voltage, capacity, roundtrip efficiency, Coulombic efficiency recorded for cycle 5 and cycle 50 and presented in the tables in Example #47. A plot of charge-discharge data for this example is shown in FIG. 8.

### Example #42—WO₃

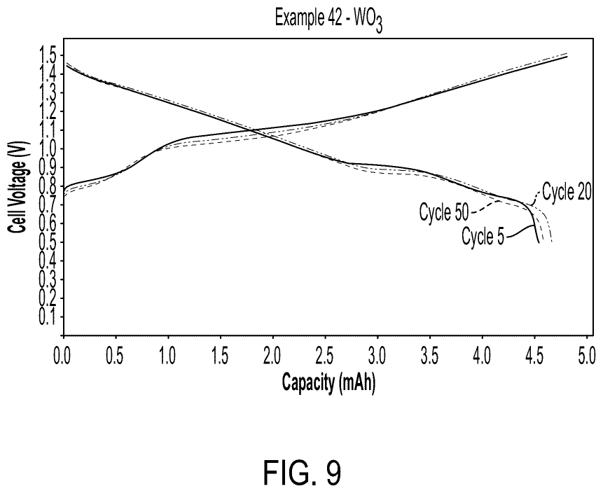

The electrode of Example #18 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/5, D/5. Discharge voltage, capacity, roundtrip efficiency, Coulombic efficiency recorded for cycle 5 and cycle 50 and presented in the tables in Example #47. A plot of charge-discharge data for this example is shown in FIG. 9.

### Example #43—MnWO₄

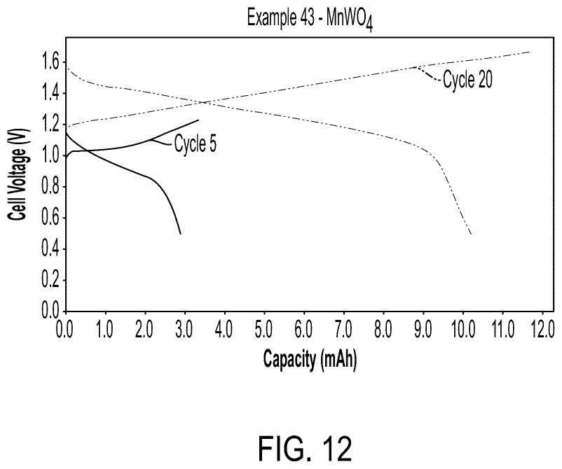

The electrode of Example #19 was used in the construction of cells as a cathode. The cell was arranged with a layer of the exemplar electrode, a separator, a mildly acidic aqueous buffered electrolyte and counter-electrode. The counter-electrode was a tungsten (VI) oxide or tungsten trioxide coated on a titanium current collector. The cells were cycled at C/5, D/5. Discharge voltage, capacity, roundtrip efficiency, Coulombic efficiency recorded for cycle 5 and cycle 50 and presented in the tables in Example #47. A plot of charge-discharge data for this example is shown in FIG. 12.

### Example #44—Sn 7% WO₃

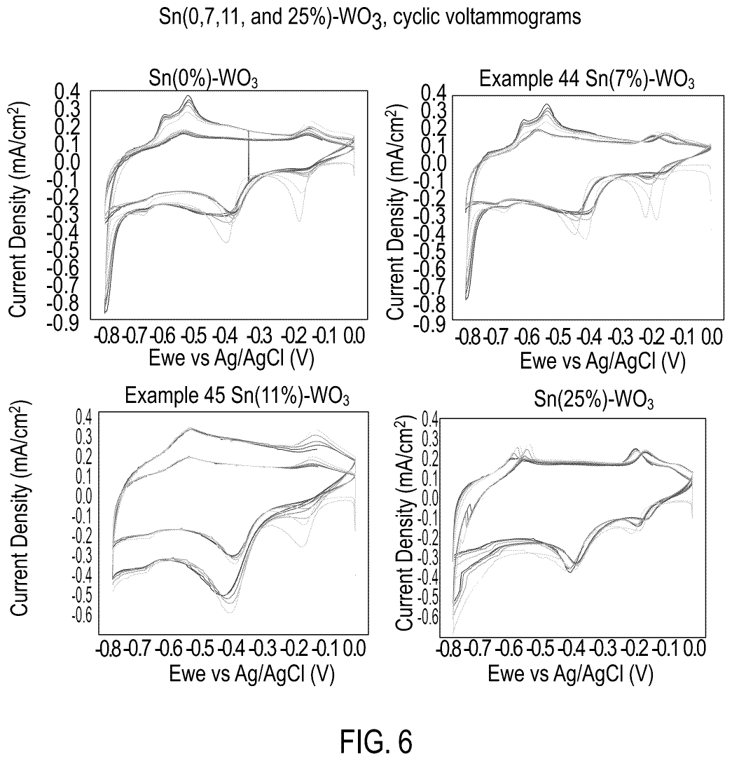

The electrode of Example #10 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/5, D/15. Discharge voltage, capacity, roundtrip efficiency, Coulombic efficiency recorded for cycle 5 and cycle 50 and presented in the tables in Example #47. A cyclic voltammogram for this example is shown in FIG. 6 with comparative examples of 0% Sn and 25% Sn provided. Two different mildly acidic aqueous buffered electrolytes were tested (blue lines for electrolyte 1 and green lines for electrolyte 2) and the lines shown get progressively darker with each cycle number.

### Example #45—Sn 11% WO₃

The electrode of Example #10 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/5, D/5. Discharge voltage, capacity, roundtrip efficiency, Coulombic efficiency recorded for cycle 5 and cycle 50 and presented in the tables in Example #47. A cyclic voltammogram for this example is shown in FIG. 6 with comparative examples of 0% Sn and 25% Sn provided. Two different mildly acidic aqueous buffered electrolytes were tested (blue lines for electrolyte 1 and green lines for electrolyte 2) and the lines shown get progressively darker with each cycle number.

### Example #46—H₂W₂O₇

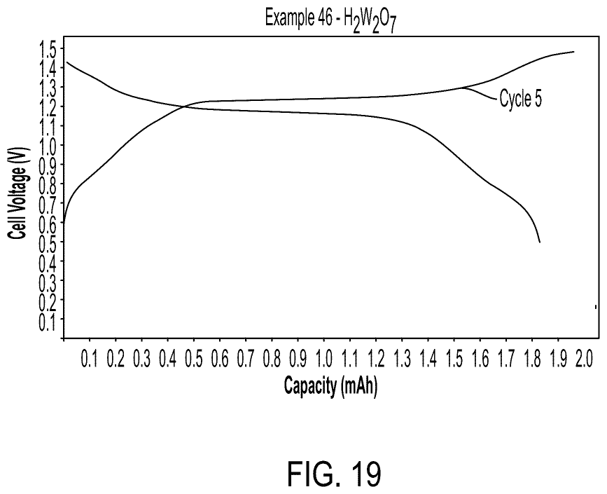

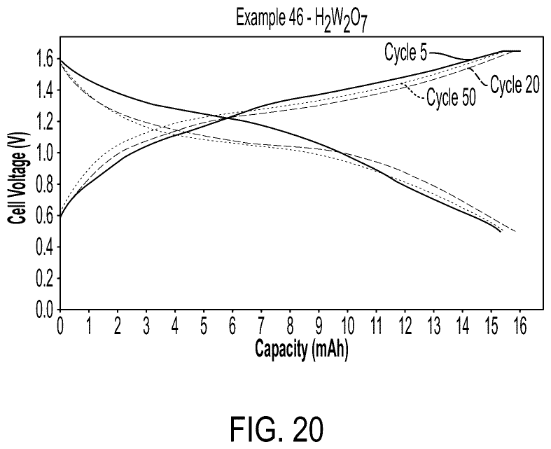

The electrode of Example #22 was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/8, D/8. Discharge voltage, capacity, roundtrip efficiency, Coulombic efficiency recorded for cycles 5, 20, and 50 are presented in the tables in Example #47. Plots of charge-discharge data for this example are shown in FIG. 19 and FIG. 20.

### Example #47 Charge-Discharge Data

Tables 1-3 below provide data that characterize cells of certain examples described herein. The leftmost column identifies the relevant example number for the row.

TABLE 1
Cycle 5 Data

| | | PSD | Electrode | Discharge | | Coulombic | Roundtrip |
|---|---|---|---|---|---|---|---|
| Example | Chemical | d50 | Density | Voltage | Capacity | Efficiency | Efficiency |
| No. | Formula | (μm) | (g/cm3) | (V) | (mAh/g) | (%) | (%) |
| 45 | Sn(11)WO₃ | 29.7 | 1.15 | 1.14 | 65.06 | 92.8 | 85.42 |
| 44 | Sn(7)WO₃ | 28.2 | 1.75 | 1.10 | 56.84 | 95.1 | 85.6 |
| 40 | SnO | 1.3 | 0.79 | 1.32 | 33.29 | 92.3 | 84.5 |
| 41 | VBiO₄ | 17.2 | 1.3 | 0.70 | 5.25 | 7.8 | 5.079 |
| 42 | WO₃ | 6.2 | 3.8 | 1.04 | 56.36 | 94.45 | 84.72 |
| 38 | Li₄Ti₅O₁₂ | 13.2 | 1.48 | 1.36 | 14.40 | 97.2 | 80.79 |
| 39 | MoO₃ | 7.9 | 1.46 | 0.87 | 113.00 | 91.8 | 58.56 |
| 43 | MnWO₄ | 18.9 | 1.13 | 1.13 | 136.60 | 91.9 | 78.24 |
| 25 | WO₃*0.6H₂O | — | 1.39 | 1.10 | 54.29 | 95.9 | 76 |
| 28 | Mn₂O₃ | — | — | 0.86 | 47.60 | 95.1 | 81.41 |
| 31 | a-MnO₂ | — | 1.621 | 0.84 | 71.60 | 99 | 86.49 |
| 34 | a-KMnO₂ | — | 0.783 | 0.80 | 65.20 | 87.2 | 73.64 |
| 34 | a-KMnO₂ | — | 2.23 | 0.95 | 50.33 | 96.7 | 73.7 |
| 46 | H₂W₂O₇ | 1.3 | 3.68 | 0.9624 | 35.93 | 95.28 | 69.78 |
| 37 | Ta₂O₅ | — | — | 0.9895 | 0.96 | 11.8 | 8.194 |
| | WO₃*0.6H₂O | | 1.19 | 1.20 | 59.63 | 95.2 | 90.88 |
| | H₂W₂O₇ | | 1.84 | 1.11 | 65.78 | 93.3 | 85.64 |
| 51 | H₂W₂O₇ | 0.6 | 2.42 | 1.08 | 57.84 | 95.6 | 80.12 |

TABLE 2
Cycle 20 Data

| | | PSD | Electrode | Discharge | | Coulombic | Roundtrip |
|---|---|---|---|---|---|---|---|
| Example | Chemical | d50 | Density | Voltage | Capacity | Efficiency | Efficiency |
| No. | Formula | (μm) | (g/cm3) | (V) | (mAh/g) | (%) | (%) |
| 45 | Sn(11)WO3 | 29.7 | 1.15 | 1.04 | 58.2 | 64.5 | 46.6 |
| 44 | Sn(7)WO3 | 28.2 | 1.75 | 1.06 | 58.4 | 97.8 | 87.7 |
| 40 | SnO | 1.3 | 0.79 | 1.28 | 30.6 | 96.5 | 84.0 |
| 41 | VBiO4 | 17.2 | 1.3 | 0.68 | 3.6 | 4.4 | 2.9 |
| 42 | WO3 | 6.2 | 3.8 | 1.03 | 57.9 | 97.1 | 87.1 |
| 38 | Li4Ti5O12 | 13.2 | 1.48 | 1.35 | 14.4 | 97.4 | 80.1 |
| 39 | MoO3 | 7.9 | 1.46 | 0.89 | 118.0 | 95.9 | 64.9 |
| 43 | MnWO4 | 18.9 | 1.13 | 1.24 | 151.5 | 87.4 | 75.2 |
| 25 | WO3*0.6H2O | — | 1.39 | 1.09 | 43.0 | 97.3 | 76.0 |
| 28 | Mn2O3 | — | — | 0.98 | 109.3 | 62.4 | 37.8 |
| 31 | a-MnO2 | — | 1.621 | 0.94 | 170.3 | 88.3 | 71.5 |
| 34 | a-KMnO2 | — | 0.783 | 0.90 | 181.5 | 91 | 71.6 |
| 34 | a-KMnO2 | — | 2.23 | 1.00 | 57.4 | 99.2 | 78.3 |
| 46 | H₂W₂O₇ | 1.3 | 3.68 | 0.9797 | 41.70 | 96.65 | 71.90 |
| 37 | Ta2O5 | — | — | 1.01 | 0.1 | 0.7 | 0.5 |
| 51 | H₂W₂O₇ | 0.6 | 2.42 | 1.01 | 59.8 | 98.8 | 79.6 |

TABLE 3
Cycle 50 Data

| | | PSD | Electrode | Discharge | | Coulombic | Roundtrip |
|---|---|---|---|---|---|---|---|
| Example | Chemical | d50 | Density | Voltage | Capacity | Efficiency | Efficiency |
| No. | Formula | (μm) | (g/cm3) | (V) | (mAh/g) | (%) | (%) |
| 45 | Sn(11)WO₃ | 29.7 | 1.15 | — | — | — | — |
| 44 | Sn(7)WO₃ | 28.2 | 1.75 | 1.05 | 58.33 | 97.7 | 83 |
| 40 | SnO | 1.3 | 0.79 | 0.90 | 23.10 | 97.1 | 56.2 |
| 41 | VBiO₄ | 17.2 | 1.3 | — | — | — | — |
| 42 | WO₃ | 6.2 | 3.8 | 1.03 | 56.93 | 95.4 | 85.49 |
| 38 | Li₄Ti₅O₁₂ | 13.2 | 1.48 | 1.35 | 14.59 | 98.4 | 80.75 |
| 39 | MoO₃ | 7.9 | 1.46 | 0.91 | 104.90 | 85.3 | 56.12 |
| 43 | MnWO₄ | 18.9 | 1.13 | — | — | — | — |
| 25 | WO₃*0.6H₂O | — | 1.39 | 1.11 | 38.10 | 98.0 | 77.1 |
| 28 | Mn₂O₃ | — | — | — | — | — | — |
| 31 | a-MnO₂ | — | 1.621 | — | — | — | — |
| 34 | a-KMnO₂ | — | 0.783 | — | — | — | — |
| 34 | a-KMnO₂ | — | 2.23 | 1.001 | 69.03 | 99.4 | 79 |
| 46 | H₂W₂O₇ | 1.3 | 3.68 | 0.9740 | 47.17 | 96.45 | 72.23 |
| 37 | Ta₂O₅ | — | — | — | — | — | — |
| 51 | H₂W₂O₇ | 0.6 | 2.42 | 1.00 | 58.39 | 96.6 | 74.33 |

### Example #48—Layered Tungsten-Based Transition Metal Oxide

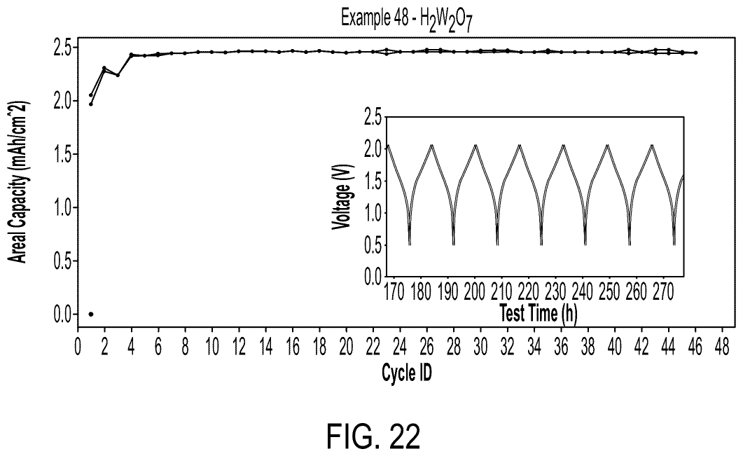

A layered tungsten-based transition metal oxide structure was used as an anode active material. An electrolyte of 1M LiTFSI in acetonitrile was used with a lithium manganese oxide cathode. Single-layer pouch cells were configured and cycled, delivering an areal capacity of ˜2.45 mAh/cm² with an average charge and discharge voltage of 1.6 V and 1.5 V respectively. FIG. 22 shows the areal capacity as a function of cycle index with the inset showing voltage profile as a function of time for a layered tungsten-based oxide anode, with lithium as the active working ions. Cells were tested in pouch cell configuration.

### Example #49—Layered Tungsten-Based Transition Metal Oxide

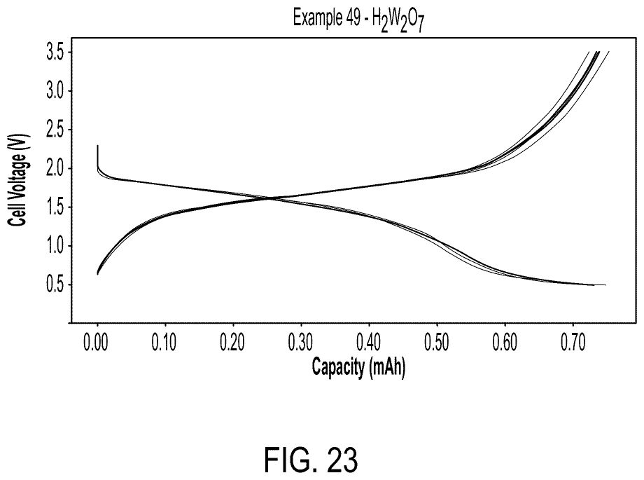

A layered tungsten-based transition metal oxide structure was used as an anode active material. The electrolyte comprised of LiPF₆ in EC:DEC and the cathode was lithium iron phosphate. Two cells were assembled using a Celgard polypropylene separator and three cells were assembled using a glass microfiber separator. All tests were conducted with 2032 coin cell form factors. The tenth cycle voltage profile of all cells (blue—Celgard, green—glass microfiber) are provided in FIG. 23 and show good reproducibility. FIG. 23 shows tenth cycle voltage profile for a layered tungsten-based oxide anode, with lithium as the working ion.

### Example #50

H₂W₂O₇ powder was produced in a wet chemical process. The crystal structure of the material can be described as a layered structure. When measured with an x-ray diffractometer using a Cu source, the diffractogram showed several major peaks in 2θ, including a first peak in the range of 6° to 12°, a second peak in the range of 16° to 22°, a third peak in the range of 22° to 28°, a fourth peak in the range of 25° to 31°, and a fifth peak in the range of 26° to 32°. The powder had a d10 of 0.4 μm, d50 of 0.6 μm and a d90 of 1.2 μm.

### Example #51

The powder from Example #50 was combined with conductive carbon, water, styrene butadiene rubber, and sodium-carboxymethyl cellulose to a titanium current collector. The exemplar powder was added at approximately 90%, the conductive carbon was added at approximately 4%, the styrene butadiene rubber was added at approximately 4% dry basis, and the sodium carboxymethyl cellulose was added at approximately 2% dry basis. The coated electrodes were dried at 80° C. for 30 minutes, though shorter times, such as 10 min, could also be used as could higher temperatures, such as, for example, 100° C. The coated electrodes can then be cut, punched, or stamped to any 2-dimensional shape or form factor for cell construction. The density of the electrode was modified to approximately 3.7 g/cm³ using a calender press.

The electrode was used in the construction of cells as an anode. The cell was arranged with a layer of the exemplar electrode, a separator, a mildly acidic aqueous buffered electrolyte and counter-electrode. The counter-electrode was manganese dioxide coated on a titanium current collector. The cells were cycled at C/5, D/5. Discharge voltage, capacity, roundtrip efficiency, Coulombic efficiency recorded for cycles 5, 20, and 50 are presented in the tables in Example #47.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In some embodiments, a first layer on a second layer can include another layer there between.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Headers have been provided for the convenience of the reader and are not intended to be limiting with respect to the claimed subject matter.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. An electrode composition for an electrochemical cell, the electrode composition comprising a redox active material comprising a tungsten oxide.

2. The electrode composition of claim 1, wherein the tungsten oxide has a layered structure.

3. The electrode composition of claim 1, wherein the tungsten oxide has a formula of X₂W₂O₇ where X is a group I element.

4. The electrode composition of claim 1, wherein the redox active material has a structure that generates an x-ray diffraction pattern using a Cu source that has a major peak measured at 2θ in (i) a range of 6° to 12°, (ii) a range of 16° to 22°, (iii) a range of 22° to 28°, (iv) a range of 25° to 31°, (v) a range of 26° to 32°, (vi) a range of 31° to 37°, or (vii) a combination thereof.

5. The electrode composition of claim 1, wherein the tungsten oxide has a cubic or hexagonal crystal structure.

6. The electrode composition of claim 1, wherein the tungsten oxide comprises WO₃.

7. The electrode composition of claim 6, wherein the tungsten oxide has a formula of zH₂O*WO₃.

8. The electrode composition of claim 7, wherein 0<z≤1.

9. The electrode composition of claim 1, wherein the tungsten oxide comprises hydrogen.

10. The electrode composition of claim 1, wherein the tungsten oxide is hydrated.

11. The electrode composition of claim 1, wherein the tungsten oxide is a reduced tungsten oxide.

12. The electrode composition of claim 1, wherein the tungsten oxide is doped.

13. The electrode composition of claim 12, wherein the tungsten oxide is doped with tin.

14. The electrode composition of claim 13, wherein the tungsten oxide is doped at a concentration in a range from 5% to 15%.

15. The electrode composition of claim 13, wherein the tungsten oxide is doped at a concentration in a range from 1% to 15%.

16. The electrode composition of claim 13, comprising particles comprising the redox active material.

17. The electrode composition of claim 16, wherein a d50 particle size of the particles is in a range of from 0.01 μm to 2 μm.

18. The electrode composition of claim 16, wherein a d50 particle size of the particles is in a range of from 0.2 μm to 20 μm.

19. The electrode composition of claim 16, wherein a d10 particle size of the particles is of from 0.01 μm to 0.8 μm.

20. The electrode composition of claim 16, wherein a d10 particle size of the particles is of from 0.1 μm to 10 μm.

21. The electrode composition of claim 16, wherein a d90 particle size of the particles is in a range of from 0.1 μm to 2 μm.

22. The electrode composition of claim 16, wherein a d90 particle size of the particles is in a range of from 0.5 μm to 50 μm.

23. The electrode composition of claim 16, wherein the particles are non-spherical.

24. The electrode composition of claim 16, wherein the particles are non-spheroidal.

25. The electrode composition of claim 16, wherein the particles have a sheet-like morphology.

26. The electrode composition of claim 1, wherein the redox active material is structured to reversibly store ions of hydrogen, ions of lithium, ions of sodium, or a combination thereof.

27. The electrode composition of claim 1, wherein the redox active material is structured such that the redox active material cannot reversibly store ions of potassium.

28. The electrode composition of claim 1, wherein the tungsten oxide has oxygen vacancies.

29. An electrode comprising the electrode composition of claim 1.

30. The electrode of claim 29, wherein the electrode is an anode.

31. The electrode of claim 29, wherein the electrode has a density in a range of from 3.5 g/cm³ to 5.2 g/cm³.

32. The electrode of claim 29, wherein the electrode has a redox active material content of at least 90 wt %.

33. The electrode of claim 29, wherein the electrode has a hydrophobic electrolyte-facing surface.

34. The electrode of claim 29, further comprising a binder and/or conductive carbon.

35. The electrode of claim 29, comprising a titanium current collector on which the electrode composition is disposed.

36. An electrochemical cell comprising an anode according to claim 29, a cathode, and an electrolyte.

37. The electrochemical cell of claim 36, wherein the anode has a hydrophobic surface in contact with the electrolyte.

38. The electrochemical cell of claim 36, wherein the electrolyte is aqueous.

39. The electrochemical cell of claim 36, wherein the electrolyte is acidic.

40. The electrochemical cell of claim 36, wherein the electrolyte has a pH of 1-5.

41. The electrochemical cell of claim 40, wherein the electrolyte has a pH of 3-4.

42. The electrochemical cell of claim 36, wherein the electrolyte is a buffered electrolyte.

43. The electrochemical cell of claim 36, wherein the electrolyte comprises a salt comprising aluminum, vanadium, manganese, iron, copper, zinc, gallium, or bismuth.

44. The electrochemical cell of claim 36, comprising a separator disposed between the anode and the cathode that prevents physical contact between the anode and the cathode.

45. The electrochemical cell of claim 36, wherein the electrochemical cell is a battery.

46. The electrochemical cell of claim 45, wherein the battery is a secondary battery.

47. The electrochemical cell of claim 46, wherein the battery has a cycle life of at least 50 cycles.

48. The electrochemical cell of claim 45, wherein the battery is a proton battery.

49. The electrochemical cell of claim 36, wherein the electrochemical cell has one or two working ions.

50. The electrochemical cell of claim 49, wherein the one or two working ions comprise a hydrogen ion, a lithium ion, or a sodium ion.

51. The electrochemical cell of claim 49, wherein the one or two working ions is two working ions comprising (i) a hydrogen ion and a lithium ion, (ii) a sodium ion and a lithium ion, or (iii) a hydrogen ion and a sodium ion.

52. The electrochemical cell of claim 49, wherein the electrochemical cell is operable to reversibly store the one or two working ions in the cathode and/or anode during charge and discharge and/or wherein the electrochemical cell is operable to transport the one or two working ions between the anode and the cathode during charge and discharge.
